(19) United States
(12) Patent Application Publication
(10) Pub. No.: US 2011/0296351 A1
(43) Pub. Date: Dec. 1, 2011

(54) User Interface with Z-axis Interaction and Multiple Stacks

(75) Inventors: Richard Alan Ewing, JR., Renton, WA (US); Jonathan L. Mann, Seattle, WA (US); Prarthana H. Panchal, Seattle, WA (US); Parker Ralph Kuncl, Seattle, WA (US); Jupiter Macleod Barton, Seattle, WA (US); Charles Goran, Seattle, WA (US); Steven A. Rossan, Seattle, WA (US)

(73) Assignee: T-MOBILE USA, INC., Bellevue, WA (US)

(21) Appl. No.: 12/852,086

(22) Filed: Aug. 6, 2010

Related U.S. Application Data
(63) Continuation-in-part of application No. 12/788,145, filed on May 26, 2010.

(51) Int. Cl. G06F 3/048

(52) U.S. Cl. 715/841; 715/854

(57) ABSTRACT

A user interface presents a plurality of items configured as a stack in a display of a device. The stack is scrollable in a direction oblique to a plane of the display for successively viewing the items in the stack. Some implementations provide multiple stacks of items laterally navigable into a viewable area of the display.

### CROSS-REFERENCE TO RELATED APPLICATION

This application is a continuation-in-part of, and claims priority to, U.S. patent application Ser. No. 12/788,145, filed May 26, 2010, the entire disclosure of which is incorporated herein by reference.

### BACKGROUND

Advances in technology have added an ever-increasing array of features and capabilities to telecommunication devices and other portable computing devices. For example, telecommunication devices may include features such as touch screens, video and still cameras, web browsing capabilities, telephony capabilities, email sending and receiving capabilities, music storing and playback capabilities, calendar and contact managing capabilities, GPS (global positioning system) location and navigation capabilities, game playing capabilities, and television capabilities, to name a few. Many of these features and capabilities are provided through specialized applications resident on the telecommunication devices. For example, many telecommunication devices allow the user to further customize the device through custom configuration options or by adding third-party software. Thus, a variety of applications, such as dedicated computer programs or software, applets, or the like, can be loaded on a telecommunication device by the consumer, the network service provider, or by the telecommunication device manufacturer. Consequently, a typical telecommunication device can maintain a large variety of applications, content items, and the like.

Further, user-friendly graphic user interfaces (GUIs) that are available on many telecommunication devices enable users to perform a wide variety of tasks, such as initiating or receiving phone calls, writing emails or text messages, browsing the Internet, managing device settings and contact lists, viewing media content, and using the large assortment of applications mentioned above. GUIs may also be specific to particular applications, such as applications developed by third party developers. However, because the number of applications and other items present on a telecommunication device may be quite large, only a portion of the applications and other items available can typically be displayed on the GUI at any one time. For example, the GUI of a typical telecommunication device often requires horizontal or vertical scrolling through a number of pages or views to locate a desired application.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 depicts an example of a device having a user interface according to some implementations disclosed herein.

FIGS. 2A-2B depict scrolling on the z-axis of the user interface according to some implementations.

FIG. 3 depicts an example of a hierarchical architecture of a user interface according to some implementations.

FIG. 4 depicts an example process for navigating a user interface hierarchy according to some implementations.

FIG. 5 depicts an example of a finger position control system according to some implementations.

FIGS. 6A-6D depict examples and processes for using the finger position control system or tilting of the device for scrolling on the z-axis according to some implementations.

FIG. 7 depicts an example of slider control according to some implementations.

FIG. 8 depicts an example of an interface having multiple sets of items scrollable along the z-axis according to some implementations.

FIGS. 9A-9B depict scrolling on the z-axis of the user interface of FIG. 8 according to some implementations.

FIG. 10 depicts an example of a flow interface according to some implementations.

FIG. 11 depicts an example of a hierarchical architecture for multiple sets of items for z-axis interaction according to some implementations.

FIG. 12 depicts an example of an upper level multiple stack interface according to some implementations.

FIGS. 13A-13B depict an example of a people-centric multiple stack interface according to some implementations.

FIG. 14 depicts an example of an application-centric multiple stack interface according to some implementations.

FIG. 15 depicts an example of a device-management-centric multiple stack interface according to some implementations.

FIG. 16 depicts an example of a media-centric multiple stack interface according to some implementations.

FIGS. 17A-17B depict examples of calendar-centric multiple stack interfaces according to some implementations.

FIG. 18 depicts an example of an interface having scrollable categories in conjunction with z-axis interaction according to some implementations.

FIG. 19 depicts an example of a component level view of a device according to some implementations.

FIG. 20 depicts an example process for navigating multiple stacks in a user interface according to some implementations.

### DETAILED DESCRIPTION

### Interactive Three-Dimensional User Interface

The technologies described herein are generally directed towards user interfaces for telecommunication devices, touch screen devices, tablet computing devices, and other portable computing devices. Some implementations provide a user interface having an interactive z-axis component. For example, some implementations provide a stack of items that are scrollable in a direction of a z-axis either toward or away from a plane of a display screen of the device. Further, implementations include a method of detecting interaction with a three dimensional user interface having an interactive z-axis dimension based on a user's finger position relative to the device. In some implementations, layers of applications or other items are presented and are scrollable in the z-axis direction. For example, a user may avoid having to move the user interface desktop left/right/up/down to locate an application, and is instead able to scroll through multiple applications or other items in the z-axis direction. The movement through the scrollable items in the z-axis direction may be activated by various controls or inputs, such as by a physical or virtual slider, a touch-free finger position sensing component, and so forth.

According to some implementations, a user interface architecture includes a set of columns or stacks of items displayed and browsable forward or backward along the z-axis direction. Each stack may have a representation on the x-axis or y-axis, such as a name or data type of the stack. For example, the name in the x-axis could be “photos” and the items contained in the stack associated with that name could be representations of albums of photos, individual photos, and so forth. The user interface architecture may also be hierarchical. For example, an item in one stack can represent a folder that includes a number of subfolders. Selection of the item can result in the display of a new set of stacks of items in the user interface in which each of the subfolders are represented along the x-axis as a stack and the items in the subfolders are represented along the z-axis as the items in the stacks.

The multiple stacks may be arranged as an upper level navigation interface in which each stack has a different centricity for enabling navigation among applications, media content, and other items and features on the device. For example, the upper level navigation interface may include an applications stack, a calendar stack, a people stack, a device management stack and a media stack. Each upper level stack may have a different centricity from the other upper level stacks. Each upper level stack may be navigated along the z-axis direction to view items contained therein, and the upper level navigation interface may be navigated along the x-axis direction to view and access other stacks of the multiple stacks in the upper level navigation flow. Further, each stack in the upper level navigation flow may be expanded to provide one or more additional multiple stack interfaces corresponding to the centricity of the particular upper level stack that was expanded. Navigation properties between adjacent stacks in the lower level flows may vary depending on the centricity of the particular lower level flow. For example, in some implementations, navigation from a current stack to an adjacent stack may result in presentation of an item in the adjacent stack at an analogous level of depth in the stack, while in other implementations, navigation to an adjacent stack results in presentation of a first or front item in the adjacent stack.

In some implementations, z-axis browsing is responsive to a detected position of a user's finger in relation to the device rendering the user interface. For example, the device may include one or more sensors for detecting a position of a user's fingertip at a spatially separated distance from the display screen of the device. Movement of the user's fingertip toward or away from the display screen of the device is detected and is interpreted into movement of the user interface along the z-axis direction. Furthermore, lateral translation of the user's finger in the left or right direction relative to the display screen can be interpreted as a panning movement of the user interface in the x-axis direction, while translation of the user's finger in the up or down direction relative to the display screen can be interpreted to pan the user interface in the y-axis direction. Accordingly, implementations herein provide for interaction with a user interface having three dimensions of movement based on a finger-position of the user.

Furthermore, in some implementations, a slider may be provided for the user to scroll in the z-axis direction. For example, in the case of a device having a touch screen display, the slider may be a virtual slider located in a portion of the touchscreen. Alternatively, a mechanical slider or similar mechanism may be provided as part of the device. Employing the slider, the user is able to flip forward and backward through layers of applications or other items displayed in the z-axis direction. In other implementations, tilting of the device is used to control interaction in the z-axis direction. For example, tilt-detection can be activated when the device is in a first position, and the tilting of the device toward or away from the user causes movement of the interface along the z-axis direction.

According to some implementations, multiple columns or stacks of multiple elements are arranged in a grid in which each column or stack represents multiple elements of a similar type. Moving the stacks horizontally or vertically, such as by using swipes, dragging or panning the stacks, moves a focus of the user interface from one element type to another, while navigation in the z-axis direction allows the user to move between individual elements of a particular type. Further, through the use of perspective when displaying the stacks of items in the user interface, a user is able to visually determine the amount of content in a stack by the size of the stack. Thus, the items represented in the user interface can be quickly browsed across several different types of data. Some implementations herein may be employed for rapidly scanning through large groups of brief content, such as contacts, social status updates, really simple syndication (RSS) blurbs, or the like. Further, implementations enable a large number of applications or items to be viewed on a single desktop without necessitating panning or scrolling in the x or y direction through multiple page views. Accordingly, the implementations of the user interface herein provide a scrollable representation of applications or items along a direction of a z-axis to compactly represent, on a single user interface view, a plurality of applications or items associated with multiple desktop user interface views.

### Example User Interface

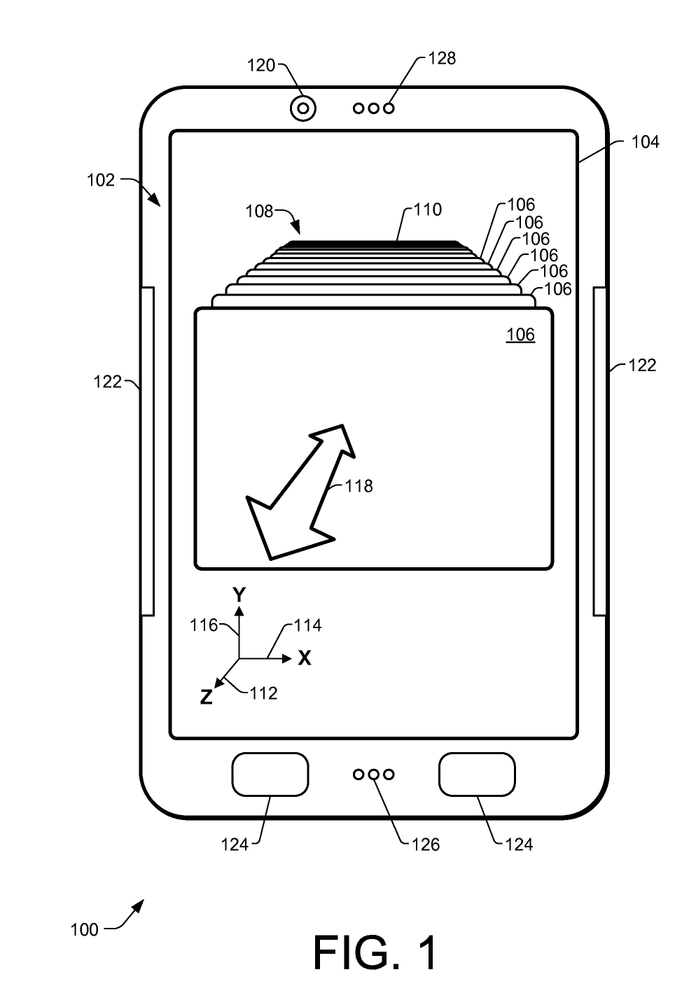

FIG. 1 illustrates an example of a device 100 having a user interface 102, such as a GUI, according to some implementations herein. Device 100 may be a telecommunication device, touch screen device, tablet computing device, or other portable computing device. The user interface 102 may be presented on a display or screen 104 of the device 100. User interface 102 includes a plurality of items 106 arranged in a column or stack 108. In some implementations, items 106 may be representations of applications present on the device 100. The stack 108 presents the items 106 so that the items 106 appear to be stacked in the direction of the z-axis 112 of an x-y-z coordinate system of the user interface 102, in which the z-axis 112 generally appears to extend outward from the display 104, while the x-axis 114 and the y-axis 116 are generally in a plane formed by the display 104. In some implementations, the z-axis may be generally perpendicular the plane of the display 104, while in other implementations, the z-axis may be at a different angle that is oblique to the plane of the display 104.

A user is able to interact with the items 106 to cause the items to move forward or backward along the z-axis, as indicated by arrow 118, so that each of the items 106 may be viewed by the user. For example, the entire stack 108 can be made to appear to move forward and outward of the display 104, so that as each item 106 reaches a certain point it will fade or disappear. The item immediately behind then becomes visible for viewing. Consequently, a user can scroll through and view a large number of items 106 in a relatively short time.

The stack 108 may be arranged with a perspective viewpoint so that as items 106 are placed toward the rear, each item 106 appears smaller and closer together with the next item than with the item in front of it until a horizon 110 is reached where the items appear to blur together. Alternatively, in other implementations, the items 106 may continue to be shown increasingly smaller to a perspective vanishing point. Thus, the stack 108 can provide a user with an indication of a number of items in the stack 108. For example, if only five items 106 are in the stack 108, then all five items can be visible. If a very large number of items are in the stack 108, then the stack may appear to extend far into the screen.

Device 100 may include various controls for controlling the user interface 102. In the illustrated example, device 100 includes a one or more finger position sensors 120 and one or more squeeze or grip sensors 122, the use of which will be described additionally below. Alternatively or in addition, a slider (not shown in FIG. 1) or other mechanism may be provided to enable scrolling in the z-axis direction, as is also discussed below. Device 100 may also include various other controls and features such as control buttons 124, an earpiece 126 and a microphone 128.

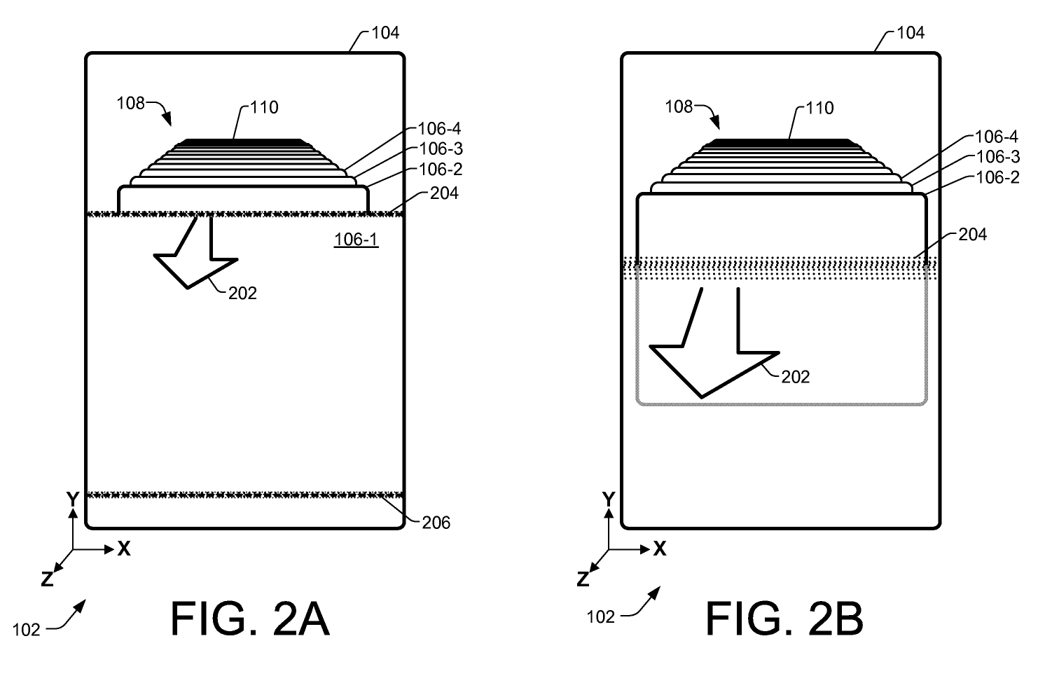

FIGS. 2A-2B depict an example of scrolling the items 106 along the z-axis. In the illustrated example, a first item 106 that is in the front of the stack 108 is scrolled forward so that item 106-1 appears to become larger and move outward from the plane of the display, toward the user in the direction of the arrow 202. Furthermore, the entire stack 108 can also appear to move in the direction of arrow 202 at the same time. As the first item 106-1 continues to grow in size, a fade effect may be provided such that the item 106-1 appears to begin to fade and the top edge 204 and bottom edge 206 may begin to blur, as illustrated in FIG. 2A. Continued movement of the first item 106-1 in the z-axis direction causes the first item 106-1 to continue to grow in size and continued to fade away as illustrated in FIG. 2B, until the first item 106-1 completely disappears and the user is presented with a complete view of the second item 106-2 in the stack 108. Consequently, a user is able to successively view each item 106 contained in the stack 108. Furthermore, in some implementations, when the end of the stack 108 is reached, the stack 108 may loop back so that the first item 106-1 may be presented again to the viewer thereby restarting the stack 108. Additionally, the user is able to reverse the direction of scrolling at any point in time so that the stack 108 appears to move inward along the z-axis, away from the user, rather than outward toward the user. Further, rather than employing the fade effect described above, each item 106 may simply disappear or appear at a predetermined point, such as when the item 106 reaches a size too large to fit within the view or focus of the user interface 102 formed by the edges of the display 104. Other variations will also be apparent to those of skill in the art in light of the disclosure here in.

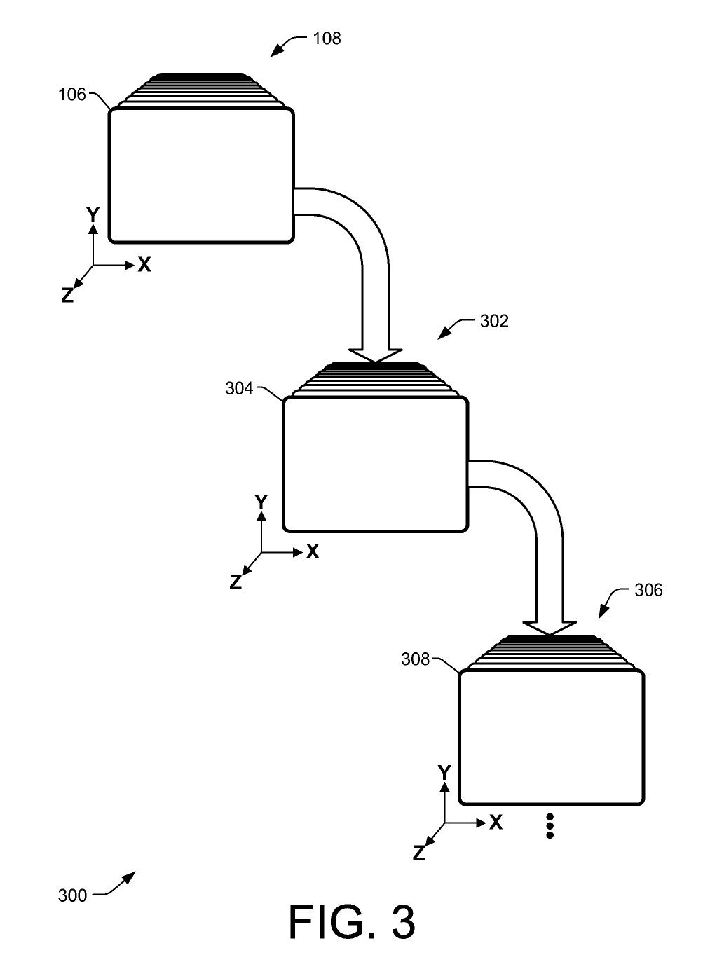

FIG. 3 illustrates an example of a hierarchical architecture 300 that may be employed in the user interface 102. A first stack 108-1 of items may be presented to a user in the user interface 102 as described above. The user may scroll through the items until a particular item 106 is located and selected by the user. For example, the items 106 may be applications available on the device 100. Suppose that the selected item is a contact application for organizing contacts of the user. The user interface 102 can then generate a second stack 302 of items 304. For instance, if the selected item 106 is a contact application, then the items 304 may be the contacts of the user. Now suppose that the user scrolls through the items 304 of the second stack 302 until a particular item 304 is located and selected. Selection of the particular item 304 may cause the user interface to generate a third stack 306 of a plurality of items 308. For example, if the user selects a particular contact as the particular item 304 in the second stack 302, then the items 308 in the stack 306 may be the information for the selected contact, such as name, address, telephone number, e-mail address, etc. Accordingly, the hierarchical architecture 300 of the user interface 102 may be applied to numerous types of applications and situations, such as photo viewing applications having photo collections, albums, and individual photos, calendar applications, word processing applications, music applications, and social networking applications, to name a few. Furthermore, to enable a user to return to an upper level stack or a root level stack, one or more controls may be provided, such as control buttons 124 mentioned above in FIG. 1.

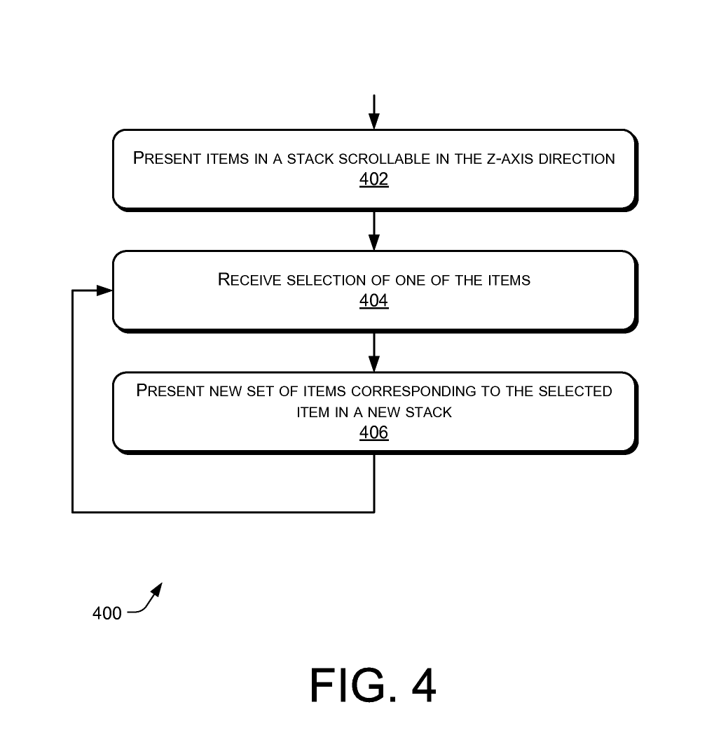

FIG. 4 illustrates an example flow diagram of a process 400 for a user interface according to some implementations herein. In the flow diagram, the operations are summarized in individual blocks. The operations may be performed in hardware, or as processor-executable instructions (software or firmware) that may be executed by one or more processors. Further, the process 400 may, but need not necessarily, be implemented using the device and interfaces of FIGS. 1-3.

At block 402, multiple items are presented in a stack that is scrollable in the z-axis direction. For example, applications, content items, or the like may be presented in a stack to a user in the user interface 102, and the user is able to scroll forwards or backwards through the stack on the z-axis to locate and select a desired item.

At block 404, the user interface receives a selection of one of the items in the stack. For example, when a user reaches a desired item, the user may stop scrolling and select the item, such as by using a designated control or, in the case of a touchscreen, tapping on the item itself, or the like.

At block 406, the user interface presents a new set of items corresponding to the selected item in a new stack. The user is able to scroll through the new stack to locate a new item to be selected. Consequently blocks 404 and 406 may be repeated a number of times depending on the depth of the hierarchy.

### Finger Position Control

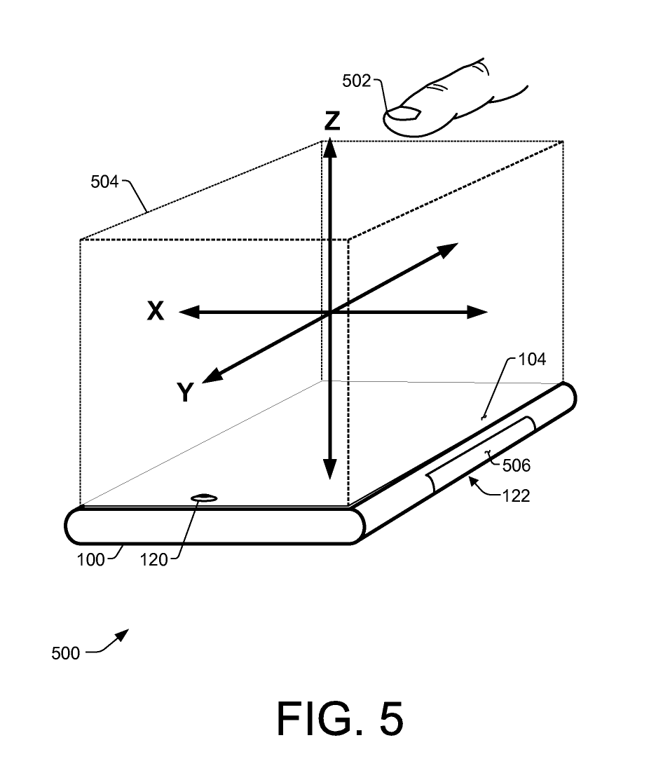

FIG. 5 illustrates an example of a finger position control system 500 that may be implemented for controlling the user interface 102. As mentioned above, device 100 may include one or more finger position sensors 120. Finger position sensor 120 may be, for example an imaging device or sensor able to recognize a fingertip 502 or other part of a user's hand, and track the movement of the fingertip 502 or other part of the user's hand within a space 504 in proximity to the device 100. In some implementations, finger position sensor 120 may detect infrared light projected from an infrared emitter (not shown) to enable use of the finger position control system 500 in the dark or in lowlight conditions. Thus, examples of finger position sensors 120 include a front-facing camera, an infrared light sensor, a non-touch capacitive sensor, or the like. When the finger position sensor 120 has recognized the fingertip 502 of the user, the finger position sensor 120 is able to track the movement of the fingertip 502 in the x, y and z directions relative to a plane of the display 104 of the device 100. These recognized movements of the fingertip 502 can be translated into interactions with the user interface 102, such as for carrying out the z-axis scrolling functions described above.

Additionally, device 100 may include one or more squeeze or grip sensors 122 as a user-activatable input mechanism located on the sides of the device 100 or in another suitable location. For instance, grip sensors 122 may be pressure sensitive sensors or switches that are activated when a sufficient predetermined pressure is applied. Grip sensors 122 are able to be grasped by a user of the device 100 and squeezed for executing certain functions in the user interface 102. For example, one use of grip sensors 122 may be to select an item currently viewed in the user interface 102, although numerous other functions may also be implemented. Further, in some implementations, grip sensors 122 may also be touch sensitive, having a touch-sensitive surface 506 that can detect, for example, the sliding of a user's finger along the surface. Consequently, in some implementations, grip sensors 122 can be used as scroller or slider for controlling interaction with the user interface in the z-axis direction. Alternatively, in other implementations, grip sensors 122 may be employed as a user-activated input mechanism used in conjunction with other inputs, such as finger position for controlling interaction in the z-axis direction. Additionally, while grip sensors are shown on the sides of device 100 in some implementations herein, in other implementations, such as in the case in which device 100 is larger than a palm-sized unit, as in the case of a tablet device, on or more grip sensors may be located elsewhere on the device, such as near one or more corners of the device (e.g., the corner of a touch-sensitive screen) on the back of the device, or other convenient location for gripping the device.

As an example, an initial fingertip position of the finger may be established near the device 100 by squeezing and holding the grip sensors 122 while positioning the fingertip 502 within proximity to the finger position sensor 120. When the initial fingertip position has been established, all movements may be track relative to that point by the finger position sensor 120. For example, movement of the finger tip 502 laterally in a plane parallel to the screen 104 of the device may be interpreted as a real-time panning motion on the user interface in the direction of finger movement.

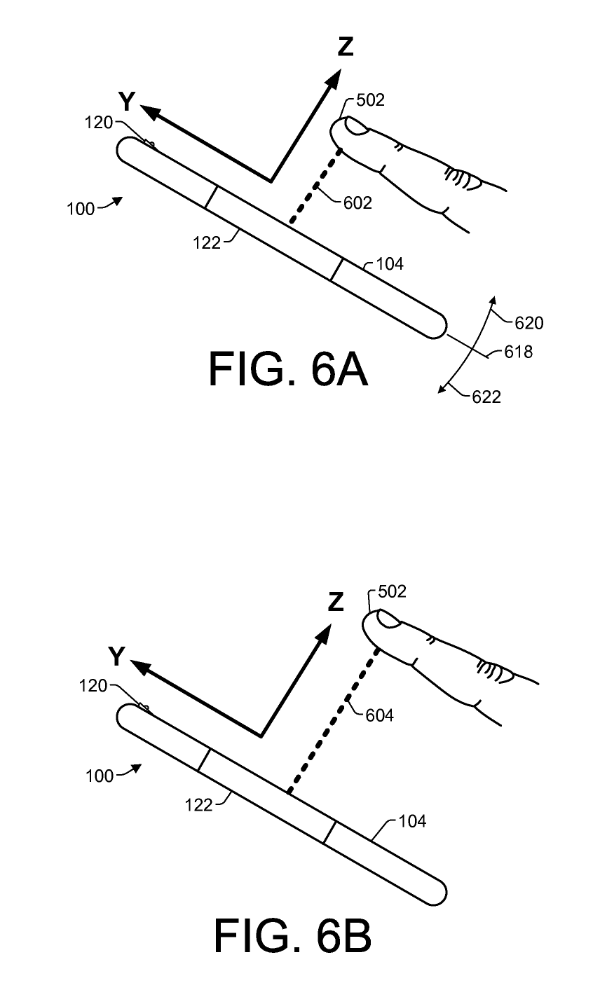

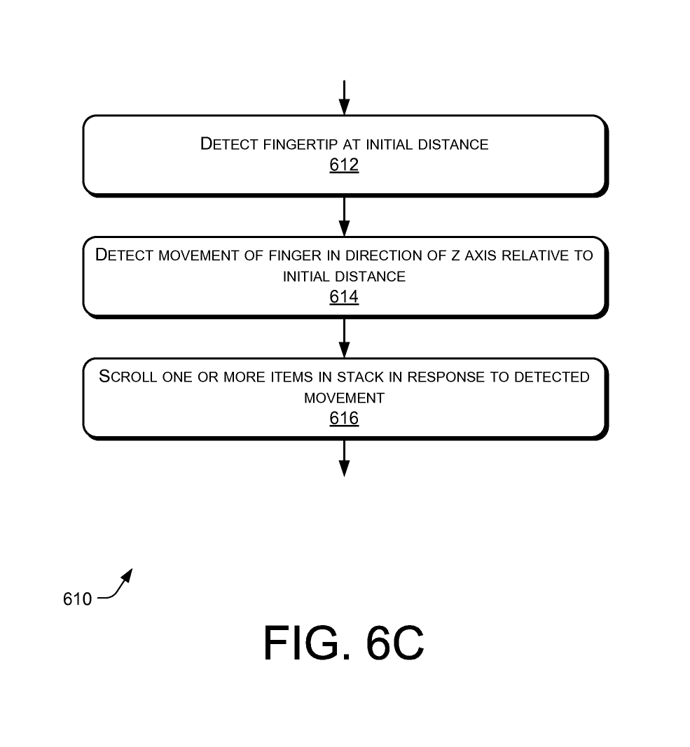

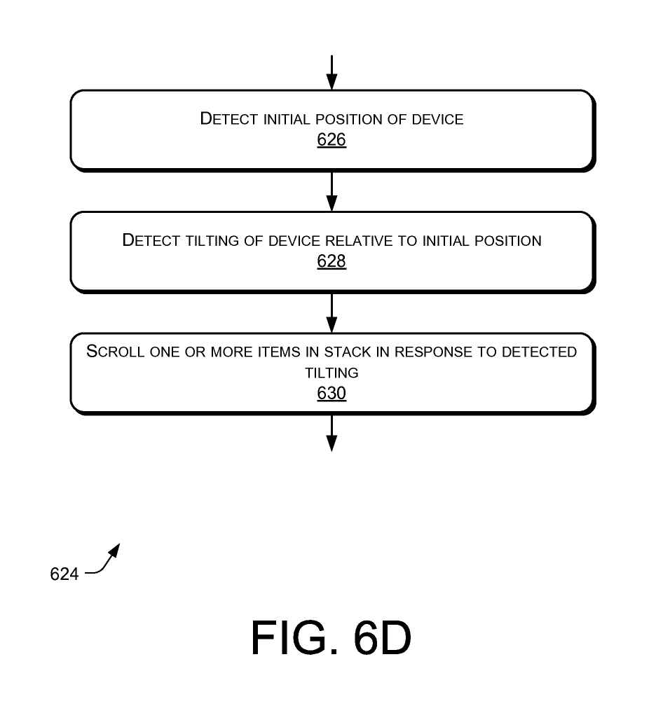

Further, as illustrated in FIGS. 6A-6B, movement of the fingertip 502 in the z-axis direction may also be tracked by the finger position sensor 120. For instance, the fingertip 502 may be located at an initial distance 602 relative to screen 104, as illustrated in FIG. 6A. The fingertip 502 may be moved to a further distance 604 from screen 104 in the z-axis direction which can result in scrolling of the stack 108 of user interface 102 in the z-axis direction, as described above, in the direction of the finger movement. Moving the fingertip 502 in the opposite direction, toward the screen 104 can result in cessation of the scrolling of the stack 108, and when the finger is positioned closer to the screen 104 than the initial distance 602, the stack 108 may scroll in the opposite direction, along the negative z-axis direction.

FIG. 6C illustrates an example flow diagram of a process 610 for a user interface according to some implementations herein. In the flow diagram, the operations are summarized in individual blocks. The operations may be performed in hardware, or as processor-executable instructions (software or firmware) that may be executed by one or more processors. Further, the process 610 may, but need not necessarily, be implemented using the device and interfaces of FIGS. 1-5.

At block 612, an initial position of the fingertip of a user is detected by the device 100. For example, an initial fingertip position may be established near the device 100 by squeezing and holding the grip sensors 122 while positioning the fingertip within proximity to the finger position sensor 120.

At block 614, movement of the finger is detected in the direction of the z-axis relative to the initial position. For example, the finger position sensor 120 may detect that the finger has moved toward or away from the initial position.

At block 616, in response to the detected movement of the finger, the user interface 102 scrolls in the direction of the z-axis by moving one or more items in the stack of items presented in the user interface as described above with respect to FIGS. 2A-2B. For example, the finger position sensor 120 may detect how far or how close the finger moves, and the user interface 102 may control the speed of the scrolling relative to the distance that the finger is moved from the initial distance. Moving the finger in opposite direction can slow or reverse the scrolling of the items.

While the finger positioning system 500 has been described in use with the user interfaces described herein, the finger positioning system 500 can also be used with other types of user interfaces for carrying out panning and zooming operations. For example, when viewing a map, the fingertip positioning system 500 in conjunction with the grip sensors 122 can be used to pan and zoom over portions of the map, and can even carry out panning and zooming in a single motion. Further, in other implementations, the finger positioning system 500 may be used for manipulating 3-D objects, 3-D spatial navigation, game control, or the like. Other uses and functions will also be apparent to those of skill in the art in light of the disclosure herein.

### Tilt Control

Additionally, or alternatively, as illustrated in FIG. 6A, tilting of the device 100 can be used to control interaction with the user interface in the z-axis direction. For example, one or more accelerometers or other motion sensors (not shown in FIG. 6A) may be provided in device 100 for controlling interaction in the z-axis direction. In some implementations, a user may squeeze grip sensors 122 when the device is in a first position 618. Tilting the device 100 in a first direction 620 from first position 618 while continuing to squeeze the grip sensors 122 causes the stack 108 to move or scroll in a predetermined direction, such as toward the user. Tilting the device back in an opposite direction 622 causes the stack 108 to scroll or move in the opposite direction, such as away from the user. Further, the degree of tilt can control the speed at which the scrolling in the z-axis direction takes place, e.g., the further the device is tilted, the greater the speed of the scrolling.

Other variations may also be used. For example, a first squeeze of the grip sensors 122 may turn on the tilt-responsive interaction with the z-axis, while a second squeeze of grip sensors 122 turns off the tilt-responsive interaction. Further, rather than using grip sensors 122, other activation mechanisms may be used, such as touching one of control buttons 124. Additionally, tilting the device to the left or right, rather than forward or backward, can be used for scrolling in the x-axis direction. As another example, touching a location on screen 104 when screen 104 is touch-sensitive may also serve as an activation mechanism for using tilting of the device for interaction with the interface in the z-axis direction.

FIG. 6D illustrates an example flow diagram of a process 624 for interacting with a user interface according to some implementations herein. In the flow diagram, the operations are summarized in individual blocks. The operations may be performed in hardware, or as processor-executable instructions (software or firmware) that may be executed by one or more processors. Further, the process 624 may, but need not necessarily, be implemented using the device and interfaces of FIGS. 1-4.

At block 612, an initial position or attitude of the device is detected. For example, an initial position of the device may be established when a user squeezes and holds the grip sensors 122. Other activation mechanisms may also be used to implement the tilting control, as discussed above.

At block 614, tilting of the device is detected relative to the initial position. For example, one or more accelerometers or other motion sensors may be used to detect tilting of the device from the initial position, such as tilting the device forward or backward around the x-axis direction, e.g., rotating part of the device toward or away from the user.

At block 616, in response to the detected tilting of the device, the user interface 102 scrolls in the direction of the z-axis by moving one or more items in the stack 108 of items 106 presented in the user interface, as described above with respect to FIGS. 2A-2B. For example, the motion sensor may detect how far the device is tilted, and the user interface 102 may control the speed of the scrolling relative to the angle of the tilt from the initial position. Tilting the device 100 in the opposite direction can slow or reverse the scrolling of the items 106. Further, tilting the device about the y-axis can cause scrolling the interface in the x-axis direction.

### Slider Control

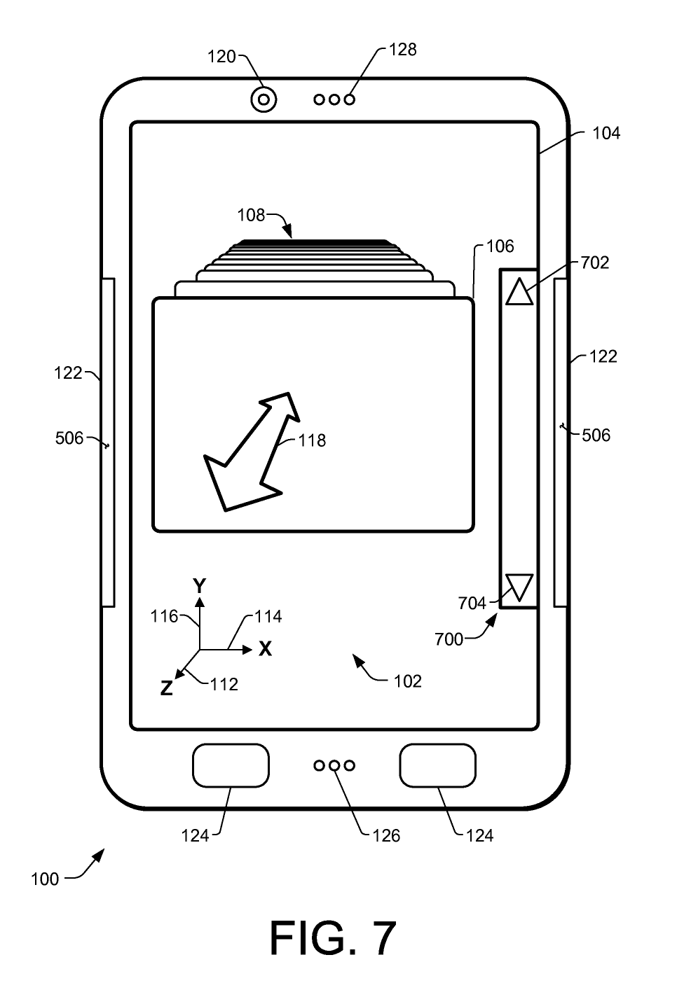

FIG. 7 illustrates an example of a slider control 700 that may be implemented in conjunction with the user interface 102 described above. The slider control 700 may be implemented in addition to or as an alternative to the finger position sensing system or the tilt control system described above. In the case in which the display screen 104 is a touch sensitive screen, slider control 700 may be a virtual control that is positioned on one side of the display screen 104. As an example, a user may place a finger on the screen 104 in the area designated as the slider control 700, and sliding the finger in one direction such as towards arrow 702 will cause the stack 108 to appear to flow outward from the screen 104, while sliding the finger in the opposite direction towards arrow 704 will cause the stack 108 to appear to move inward away from the user. Further the screen 104 may include pressure sensitive areas located at arrows 702, 704, which when pressed by a finger will cause the stack 108 to flow or scroll in the designated direction so long as the user continues to apply pressure.

Further, as mentioned above with reference to FIG. 5, grip sensors 122 may be touch sensitive, and may serve in place of or in conjunction with slider control 700. For example, a user may slide a finger along the surface 506 of one of grip sensors 122 in a first direction to cause the stack 108 to scroll in a first direction on the z-axis, while sliding the finger along the surface 506 in the opposite direction causes the stack 108 to scroll in the opposite direction. The grip sensors 122 may also include pressure sensitive areas that serve a purpose similar to that of arrows 702, 704 of slider control 700, as discussed above. Other variations for controlling the z-axis interaction will also be apparent in light of the disclosure herein, with the foregoing being mere examples. In addition, as mentioned above, a physical sliding mechanism or scroll wheel (not shown) may also be provided with the device 100, such as in the case in which the screen 104 is not touch sensitive and/or grip sensors 122 are not provided.

### Multiple Stack Interface

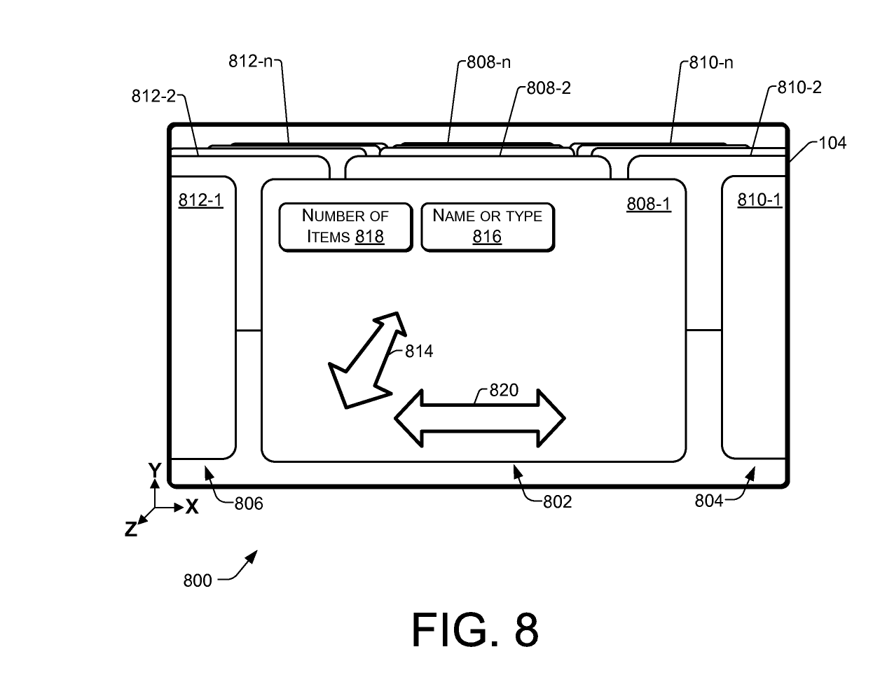

FIG. 8 illustrates an example of a user interface 800, such as a GUI, that includes multiple columns or stacks of multiple items. In some implementations, for improved viewing of the items, the device display 104 may be horizontally oriented as illustrated; however the x-y-z-coordinate system of the user interface 800 may still be maintained in the same orientation regardless of the orientation of the device. For example an accelerometer or other motion sensor (not shown in FIG. 8) can detect when the device display is rotated between portrait and landscape mode, and the user interface can rotate accordingly to maintain the orientation of the coordinate system.

In the illustrated example, the user interface 800 includes multiple stacks 802, 804, 806, in which each stack is made up of multiple items. For example, stack 802 is made up of items 808-1, 808-2, . . . , 808-n; stack 804 is made up of items 810-1, 810-2, . . . , 810-n; and stack 806 is made up of items 812-1, 812-2, . . . , 812-n. The view or focus of the user interface 800 is sized so that a single stack 802 is viewable and large enough to present meaningful information, while a portion of the adjacent stacks 804, 806 are shown to the right and left, respectively, to enable intuitive navigation to the adjacent stacks. Similar to the implementations described above, the items in each stack are displayed and browsable forward or backward along the z-axis direction, as indicated by arrow 814.

Each stack 802-806 may have a representation on the x-axis, such as a name or data type 816 of items in the stack, and may also include an indication 818 of the number of items in the stack. In some implementations, the different stacks may represent different data types or information. For example, one stack may be for contacts, one stack for e-mail, one stack for a calendar, etc. Furthermore, the focus of the user interface may be switched from one stack to an adjacent stack by scrolling or dragging of the stacks in the direction of the x-axis, as indicated by arrow 820. For example, stack 802 may be moved to the left into the position currently occupied by stack 806, which would put stack 804 in the focus of the user interface. This left/right panning or scrolling may be conducted at any location in the stack, thereby switching between data types at the current level of depth, as will be described additionally below.

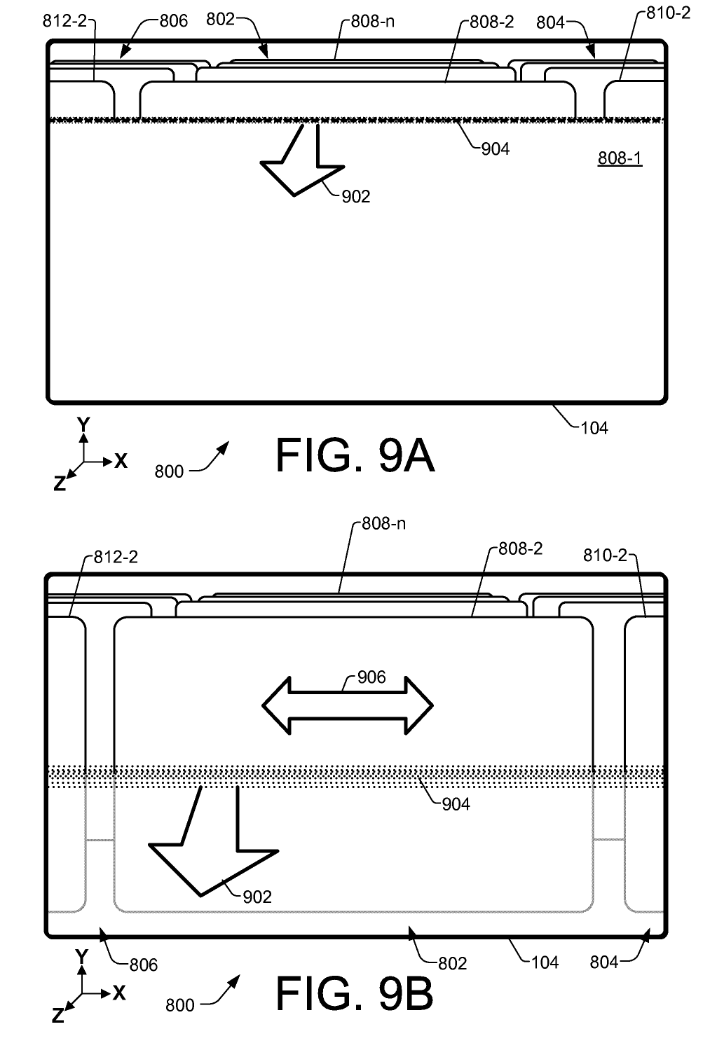

FIGS. 9A-9B depict an example of scrolling the items 808-1, . . . , 808-n of stack 802 along the z-axis. In the illustrated example, a first item 808-1 that is in the front of the stack 802 is scrolled forward using a control such as the finger position system or slider controls described above. During scrolling, item 808-1 appears to become larger and move outward from the plane of the display 104 and toward the user in the direction of the arrow 902. Furthermore, the entire stack 802, and stacks 804 and 806 as well, will also appear to move in the direction of arrow 902 at the same time. As the first item 808-1 continues to grow in size, a fade effect may be provided such that the first item 808-1 appears to begin to fade and the top edge 904 may begin to blur, as illustrated in FIG. 9A. Continued movement of the first item 808-1 in the z-axis direction will cause the first item 808-1 to continue to grow in size continued to fade away as illustrated in FIG. 9B, until the first item 808-1 completely disappears and the user is presented with a complete view of the second item 808-2 in the stack 802.

Consequently, a user is able to successively view each item 808 contained in the stack 802. Furthermore, in some implementations, when the end of the stack 802 is reached, the stack 802 may loop back so that the first item 808-1 is presented again to the viewer thereby restarting the stack 802. Additionally, the user is able to reverse the direction of scrolling at any point in time so that the stack 802 and the stacks 804 and 806 appear to move inward along the z-axis, away from the user, rather than outward from the user interface. Further, rather than employing the fade effect described above, each item 808 may simply disappear or appear at a predetermined point, such as when the item 808 reaches a size too large to fit within the view of the user interface 800. Other variations will also be apparent to those of skill in the art in light of the disclosure here in.

Additionally, as depicted in FIG. 9B, when item 808-2 is presented, the user may continue to scroll forward or backwards in the z-axis direction, or alternatively, the user may scroll in the x-axis direction, as indicated by arrow 906. This enables the user to directly switch from one data type to another data type without having to return to the front of the stack of a particular data type. For example, the user may move directly from item 808-2 to item 812-2, which is of a different data type, but at the same level of depth as item 808-2. Alternatively, in other implementations when the user attempts to scroll in the x-axis direction to an adjacent stack 804, 806 from within the stack 802, the user interface 800 may automatically reposition the focus at the front or first item of the adjacent stack 804, 806. The lateral scrolling in the x-axis direction may be performed in response to sensing a change in position of a fingertip due to lateral movement, as described above, or may be performed in response to a swipe or drag performed on a touch screen of the device 100, or other navigation command. In other implementations, multiple stacks may be arranged to be scrollable in the direction of the y-axis for moving from one stack to the next stack, rather than in the direction of the x-axis. Further, in some implementations the multiple stacks may be laid out in a grid in which the user may navigate in both the x-axis direction and the y-axis direction for moving between multiple stacks of different data types, content items, applications, and so forth, each scrollable in the z-axis direction.

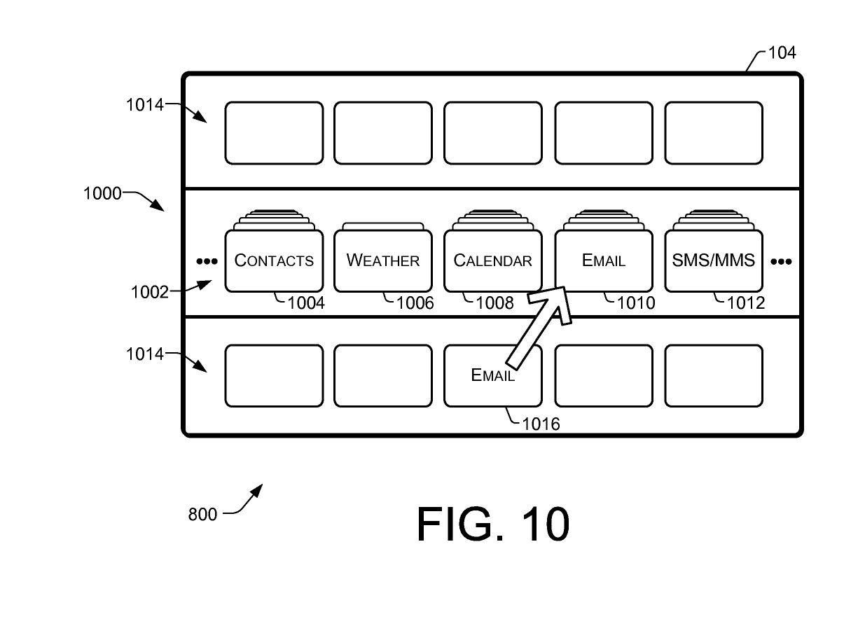

As illustrated in FIG. 10, some implementations of the user interface 800 may be configured as a ribbon or flow 1000 of stacks 1002 containing updates and information to be provided to a user. For example, the flow 1000 may include stacks of various different data types, with the most recent update to the data type presented as the front or first item in the corresponding stack. In the illustrated example, the stacks 1002 of data types include contacts 1004, weather 1006, calendar 1008, e-mail 1010, and SMS/MMS content 1012. The user can zoom out to view all the available data 1014 for the flow 1000 as illustrated in FIG. 10, and then choose to add or remove particular data types to and from the flow 1000. For example, as illustrated in FIG. 10, the user has decided to drag the e-mail icon 1016 into the flow 1000, thereby placing the e-mail stack 1008 into the flow 1000. When the user is finished adding or removing the data types from the flow 1000, the user can zoom back in and be presented with a user interface 800, such as that illustrated in FIG. 8 described above.

Additionally, in some implementations, rather than adding or removing entire data types to the flow 1000, a user may add one or more items of a particular data type. For example, if the user has received updates from a social networking site, the user can add one or more updates of interest to the flow 1000 for subsequent review, while leaving other updates out of the flow 1000. For example, if the user has a stack for the social network, the selected one or more items are added to the stack, or the selected items may merely be added to the flow 1000 separate from any other stack.

In another variation, rather than having the user add stacks to the flow 1000, one or more stacks may be automatically added, such as when one or more relevant updates are received for a particular data type. For example, suppose that the user receives a new text message. Upon receipt of the text message, the SMS/MMS stack 1012 may be automatically added to the flow 1000. After the user has viewed the text message, the SMS/MMS stack 1012 may then automatically be removed from the flow 1000. When another new text message is received, the SMS/MMS stack 1012 is again added back to the flow 1000. This automatic addition and removal of stacks can be extended to include updates to any of the different data types. Further, rather than adding an entire stack that includes both new updates and items already viewed, the items or stacks added to the flow 1000 may be just the newly received or updated items. As another example, one of the stacks in the flow 1000 may be designated as containing newly-received updates of various different data types. Thus, the user can then just scroll through this one stack to view updates to various difference data types, e.g., new text messages, new emails, new social networking updates, or the like. These updates can also be added to their corresponding data type stack as well, to provide the user with the option to view updates according to data type.

In some implementations, the flow 1000 may be configured to automatically scroll across the view in the x-axis direction and momentarily pause on each stack before moving to a subsequent adjacent stack. The flow 1000 may loop to create a continuous experience. The flow direction and speed may be adjusted by the user, and when the user wishes to view a particular stack's content, the user can stop the flow such as with a finger tap and scroll along the z-axis to view the content of the particular stack. Furthermore, in addition to including the name of the data type 816 described above, the stacks may be visually distinct from each other in other ways, such as being color-coded, having distinct icon shapes, or the like. Additionally, the number of items in each stack may be visually indicated by depth of the stack, as discussed above, and/or the numerical indicator 818 may indicate the number of items in each stack. Furthermore, while the flow 1000 has been described in some implementations as displaying recent updates and information, in other implementations, the flow 1000 may be populated with stacks of other types. For example, the user may populate the flow 1000 with applications that the user frequently uses, or the like. Further, while some implementations provide constant movement of the flow 1000, in other implementations the movement is only initiated by the user, such as by swiping on a touch screen, or by activation of a control, slider, or the like.

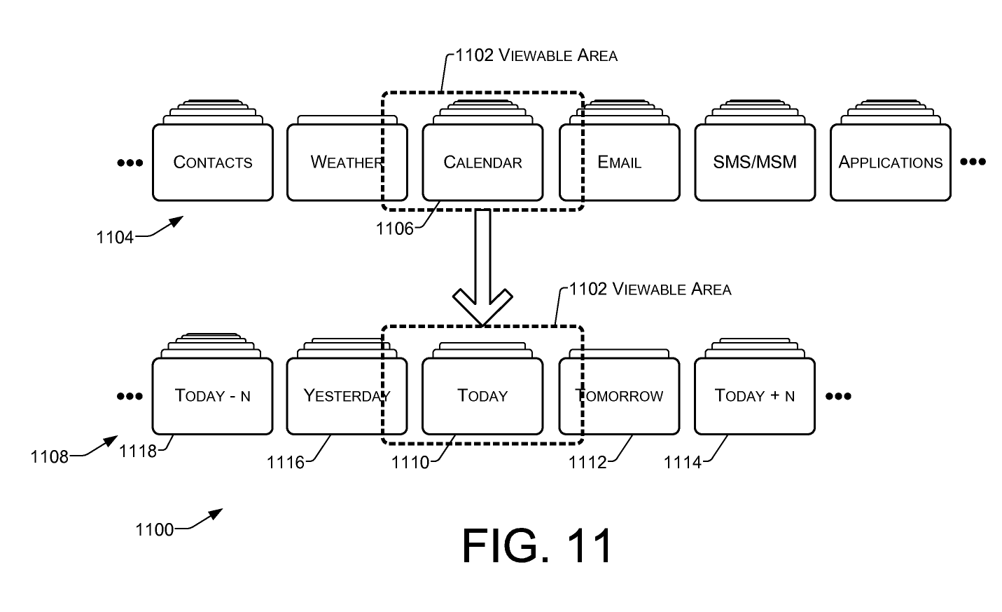

FIG. 11 depicts a hierarchical architecture 1100 that may be applied in some implementations of the user interface 800. FIG. 11 illustrates a focus or viewable area 1102 of the user interface 800 through which a plurality of stacks 1104 of data types may be moved, viewed and accessed as described above. Further, as illustrated in FIG. 11, in some implementations, the user interface may also create a plurality of stacks of data types for a particular selected application or data type when selected by the user. For example, when the user selects the calendar application 1106, the user interface can create a new plurality of stacks 1108 corresponding to the selected application or data type. For example, for the calendar application 1104, the stacks 1108 may include a stack 1110 for the current day that may include a plurality items, such as a plurality of appointments or time periods for the current day that are viewable by scrolling along the z-axis. The stacks 1108 may further include a plurality of other stacks viewable by movement of the stacks into the focus along the x-axis direction, such as a tomorrow stack 1112, one or more stacks 1114 for one or more days after tomorrow, a yesterday stack 1116, and one or more stacks 1118 for one or more days prior to yesterday, each of which may include items scrollable along the z-axis, as described above. Thus, the calendar application stack 1104 may be expanded to present a plurality of stacks that provide a day view of a calendar, in which each stack represents a day, and each stack includes a plurality of items representing time periods in the day, such as hours.

Further, as mentioned above, the user may move to an adjacent stack at any point during navigation of the z-axis. For example, suppose that the today stack 1110 contains items representing one hour time periods for creating appointments, and the user has navigated along the z-axis of the today stack 1110 to determine whether an appointment is already scheduled for 3:00 pm. If so, the user my swipe or otherwise activate a control to move the plurality of stacks 1108 to the left so that the 3:00 pm time slot of the tomorrow stack 1112 is immediately presented in the focus or viewable area 1102, rather than the first item in the tomorrow stack 1112. The user can then determine whether the 3:00 pm time period is available tomorrow. If not, the user may move on to the next adjacent stack 1114 (i.e., the day after tomorrow) and be immediately presented with the 3:00 pm time period for that day, and so forth. Other navigation variations are also possible, as described additionally below.

### Upper Level Interface

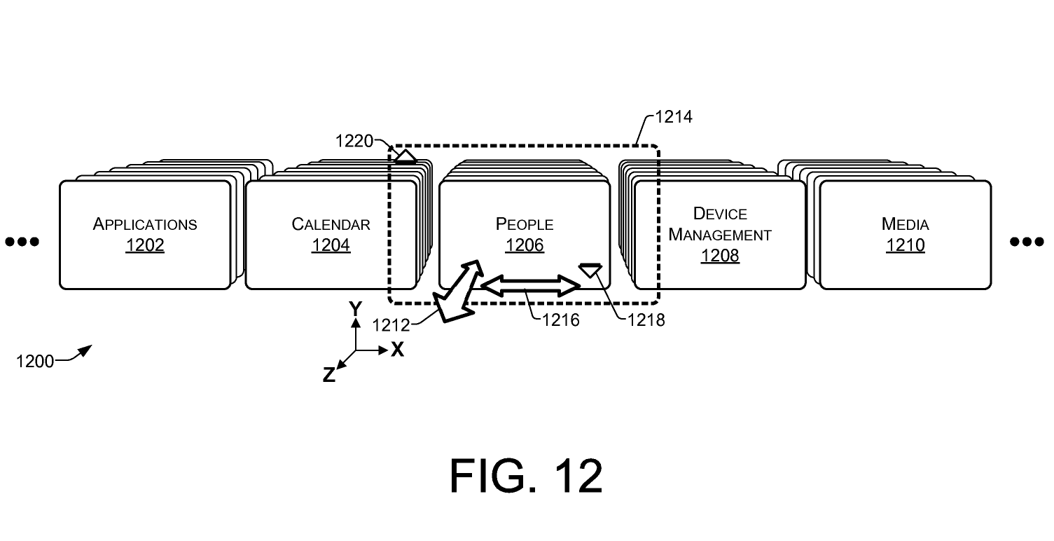

FIG. 12 illustrates an example of a plurality of stacks as an upper level navigation interface 1200 according to some implementations. Examples of stacks that may be included in upper level interface 1200 include an applications stack 1202, a calendar stack 1204, a people stack 1206, a device management stack 1208 and a media stack 1210, although additional or alternative types of stacks may also be included. Each upper level stack 1202-1210 may have a different centricity from the other upper level stacks 1202-1210. Additionally, each upper level stack may be navigated along the z-axis to view items contained therein, as indicated by arrow 1212, in the manner described above. For example, the applications stack 1202 may contain some or all of the applications on the device arranged, e.g., in alphabetical order, order of most frequent use, or the like. A user may move the applications stack 1202 into a viewable area or focus 1214 of the user interface and may scroll through the items in the application stack 1202, where each item in the stack is a representation of a different selectable application. Similarly, the calendar stack 1204 may contain the months or days of the year as selectable items navigable in the z-axis direction. Further, the people stack 1206 may contain a list of contacts or the like listed in a particular order, such as alphabetically by first or last name, or other suitable order. The device management stack 1208 may include a plurality of representations for accessing device management functions, such as for controlling device settings. The media stack 1210 may contain a plurality of media content items, such as photographs, music, videos, television shows, movies, or the like.

As discussed above, as indicated by arrow 1216, the user may move a desired stack 1202-1210 into the focus 1214 by swiping or dragging in the case of a touch screen, by using mechanical controls, or other suitable control mechanism. Further, in some implementations, any of the multiple stack interfaces herein, including the upper level interface 1200, may be configured as a flow to automatically alternate between sequential presentation of each of the stacks 1202-1210, such as by continually scrolling each of the stacks 1202-1210 through the focus 1214, and optionally stopping for a brief period of time before presenting the next stack in the sequence.

Each stack 1202-1210 may be expanded into a plurality of additional stacks of a lower hierarchical level and having configurations based on the centricity of the corresponding upper level stack 1202-1210. Further, each set of lower level stacks may have different navigation properties based on the centricity of the particular upper level stack 1202-1210 from which they originate. For example, in some implementations, navigation from a first stack to an adjacent stack may result in direct display of an item that is analogous to an item that was displayed in the first stack. In some implementations, an analogous item might simply be an item at the same level of depth in the stacks along the z-axis direction, while in other implementations an analogous item might be an item directly related to a current item, e.g., related to the same person, same subject, same time period, or the like. Further, in other implementations, navigation to an adjacent stack results in display of a beginning of the adjacent stack.

In some implementations, an expansion control 1218, such as a virtual control, may be displayed in the focus 1214 in conjunction with a stack 1202-1210. For example, the expansion control 1218 may be touched or tapped on by the user to expand the selected upper level stack 1202-1210 into a plurality of corresponding lower level stacks based on the centricity of the selected upper level stack. Additionally, a collapse control 1220 may also be provided to enable the user to move back up a hierarchy of stacks from a lower level to a higher level. For example, pressing the collapse control 1220 once may result in display of a next higher level hierarchy, while pressing and holding the collapse control 1220 for a predetermined period of time or pressing multiple times may result in navigation to a highest level of the hierarchy. Further, while the examples herein discuss a virtual expansion control 1218 and collapse control 1220 displayed in conjunction with a touch screen, other types of controls may also be used for expansion and collapsing, such as double tapping on a selected stack, certain gestures or actions on a touch screen, mechanical controls provided on the device, or the like.

### People-Centric Interface

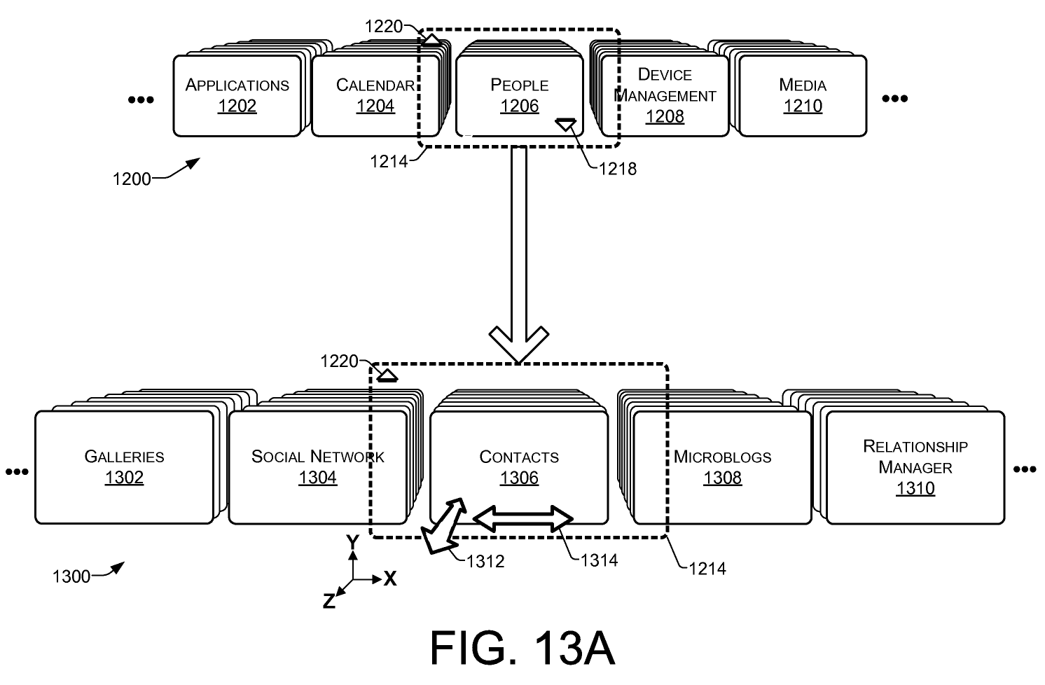

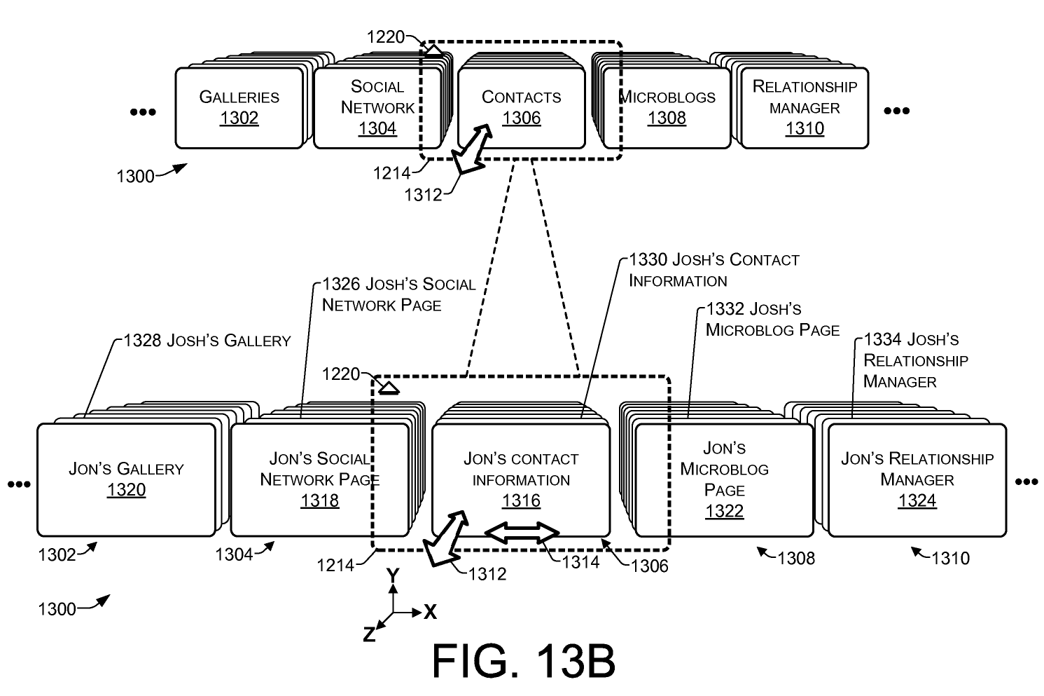

FIG. 13A illustrates an example of expansion of the upper level people stack 1206 into a separate people-centric interface 1300 of multiple corresponding lower level stacks. In this example, the people stack 1206 is a people-centric stack that is expandable into people-centric interface 1300 having a plurality of people-centric lower level stacks. For example, each lower level stack may represent a different application or grouping of items relating to a plurality of people, such as a gallery stack 1302, one or more social network stacks 1304 (e.g., FACEBOOK®, MYSPACE®, etc.,), a contacts stack 1306, a microblog stack 1308 (e.g., TWITTER®), a relationship manager stack 1310, and so forth. A user may navigate along the z-axis direction as indicated by arrow 1312 to locate a particular item in a stack 1302-1310, or the user may navigate in the x-axis direction to position a particular stack 1302-1310 within the focus 1214.

The galleries stack 1302 may contain galleries of photographs or videos arranged according to people shown in the images, such as may be identified through tagging of the images, or the like. A user may navigate through the galleries in the z-axis direction to locate a gallery of a particular person. The social network stack 1304 may contain social network pages of social network friends arranged alphabetically, by frequency of contact, or the like. A user may scroll through the social network stack 1304 in the z-axis direction to locate a social network page of a particular person. Similarly, the user mage navigate through the contacts stack 1306 to locate a contact page for a particular person. The microblog stack may include a plurality of microblog pages that the user follows, and the user may navigate along the z-axis to locate a particular page for a particular person. Further, the relationship manager stack 1310 may correspond to a relationship management application that enables users to maintain connectivity with selected individuals. For example, the relationship manager may determine a length of time since a last communication with the selected individual and provide reminders to the user to maintain contact when the length of time exceeds a predetermined threshold.

FIG. 13B illustrates an example of navigating the people-centric interface 1300 according to some implementations. For example, when the focus 1214 is on the contacts stack 1306, the user may navigate along the z-axis in the direction of arrow 1312 through the contacts stack 1306 to locate the contact information of a first person named Jon so that an item 1316 is presented providing Jon's contact information. At this point, the user may decide to navigate in the x-axis direction to one of the other stacks 1302, 1304, 1308, 1310. According to some implementations, rather than being redirected to the front or beginning of the adjacent stack, the user is immediately presented with an analogous item having information related to Jon in the newly presented stack. For example, suppose that the user drags or otherwise navigates the social network stack 1304 into the focus 1214, an item 1318 of the social network stack 1304 that displays Jon's social network page may be immediately visible to the user as the user moves the social network stack 1304 into the focus 1214.

In some implementations, as the user navigates along the z-axis in any one of the stacks 1302-1310, the other stacks 1302-1310 also scroll to the same depth level, and the user is able to peripherally witness this scrolling of adjacent stacks by movement of the items of the adjacent stacks partially visible within the focus 1214. However in other implementations, the scrolling effect of the adjacent stacks is not necessarily provided. In any event, when the user has navigated along the z-axis to an item relating to Jon, subsequent lateral navigation the x-axis direction to any the stacks may result in direct presentation of a corresponding item relating to Jon from that stack. In the illustrated example, the user navigates along the z-axis direction to item 1316 containing Jon's contact information in the contacts stack 1306. The user then can navigate in the x-axis direction to the social network stack 1304 and be presented with item 1318 representing Jon's social network page. The user may continue navigation in the x-axis direction to the galleries stack 1302 and be presented with an item 1320 representing Jon's gallery (e.g. a gallery of images containing or related to Jon). Similarly, navigation in the opposite direction along the x-axis (or continued navigation in the same direction along the x-axis) brings the microblog stack 1308 into the focus 1214, and immediately presents an item 1322 displaying Jon's microblog page, while navigation of the relationship manager stack 1310 into the focus 1214 presents an item 1324 displaying Jon's relationship manager information.

As a further example, suppose that a second person, for example Josh, immediately follows alphabetically behind Jon among the people that the user interacts with in at least one of the stacks 1302-1310. When the user navigates along the z-axis direction from, for example, item 1318 displaying Jon's social network page to the next item 1326 displaying Josh's social network page, Josh's social network page is presented in the focus 1214. Subsequent navigation in the x-axis direction will present an item 1328 displaying Josh's gallery, an item 1330 displaying Josh's contact information, an item 1332 displaying Josh's micro-blog page, and an item 1334 displaying Josh's relationship manager information. Consequently, in these implementations, navigation in the x-axis direction results in presentation of items in adjacent stacks that are analogous or at a same level of depth as the current stack, i.e., items corresponding to the same person.

Furthermore, suppose that Jon does not have, for example, a social network page. In this case, the user may be presented with an item that indicates that Jon is not currently associated with a social network page and that provides the user with an invitation to locate or provide information to link Jon to a social network page. This concept can be extended to the other stacks 1302-1310 in the people-centric interface 1300, such that whenever a page or information is missing for a particular person in one or more of the stacks 1302-1310, the user may be presented with an opportunity to add information for the particular person to that stack, rather than being presented with a blank item or the like. For example, suppose that the user has just added a new friend on the social network, and the user navigates in the direction of the z-axis to the new friend's page in the social network stack 1304. If the user then navigates laterally to the contacts stack 1306, the interface may automatically create a contact item, add the new friend's name to the contact item, and present the contact item along with an invitation for the user to fill in other contact information for the new friend. If the user then navigates to the microblog stack 1308, the user may be presented with an item inviting the user to add the new friend's microblog information, and so forth. Additionally, while lateral navigation has been described as occurring at the same level of depth throughout the people-centric stacks 1302-1310, in other implementations, the user may be provided with the opportunity to change the default navigation so as to automatically relocate the focus to the beginning item of an adjacent stack, or other such variations. Further, should the user desire to navigate back to the upper level interface 1200, the user may simply press the collapse button 1220 to close the people-centric interface 1300 and be presented with the upper level interface 1200.

### Application-Centric Interface

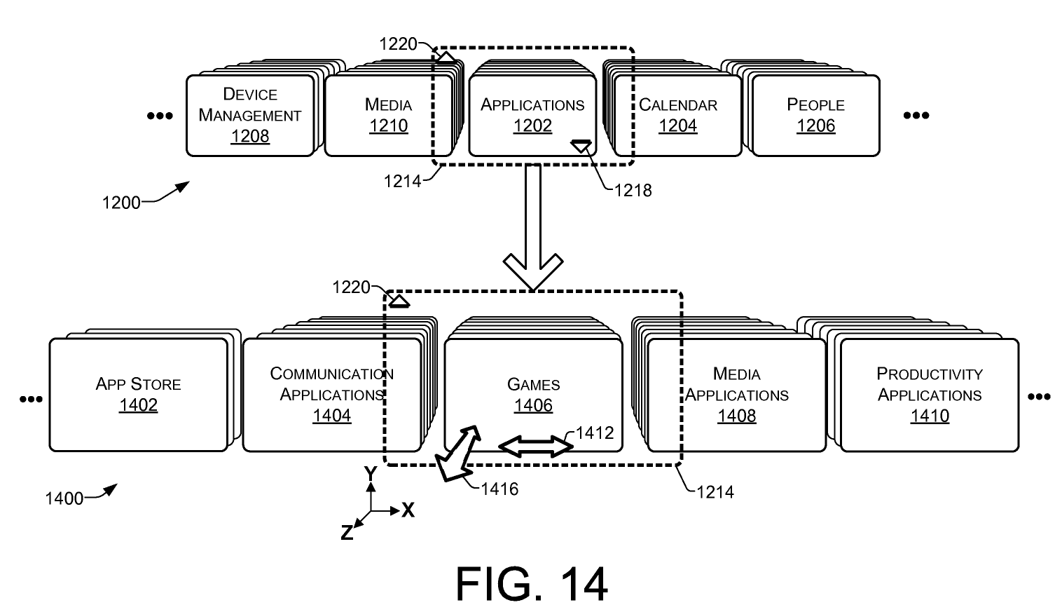

FIG. 14 illustrates an example of an application-centric interface 1400 according to some implementations. For example, a user may locate the applications stack 1202 within the focus 1214, and activate the expand control 1218 to expand the applications stack 1202 into the application-centric interface 1400 for presenting a plurality of application-centric stacks. Non-limiting examples of application-centric stacks may include an application store stack 1402, a communication applications stack 1404, a games stack 1406, a media applications stack 1408, and a productivity applications stack 1410. Thus, according to some implementations, each stack 1402-1410 in the application-centric interface 1400 may be associated with a different category or type of application, and may have items representing corresponding applications contained in the appropriate stack.

The application store stack 1402 may include items that represent one or more application stores that a user may access to obtain additional applications. Communication applications stack 1404 may include a plurality of items representing communication applications, such as arranged in alphabetical order or order of most frequent use. Similarly, the games stack 1406 may include a plurality of items representing different games that the user can access, the media applications stack 1408 may include a plurality of items representing media applications that the user can access, and the productivity applications stack 1400 may include a plurality of items representing productivity applications that the user can access. Further, when the user reaches the end of any of the application stacks 1404-1410, the user may be presented with an item that invites the user to connect directly to the application store to add more applications, or the like.

Navigation within the application-centric interface 1400 can be configured to take place differently than that described above for the people-centric interface 1300. For instance, there is typically little correspondence or relationship between the applications in one stack 1404-1410 and applications in an adjacent stack 1404-1410. Therefore, according to some implementations, navigation to an adjacent stack along the x-axis, as indicated by arrow 1412, can result in the user being presented with the first or beginning item in the adjacent stack regardless of the level of depth to which the user has navigated in the previous stack. For example, suppose that the user navigates along the z-axis in the games stack 1406, as indicated by arrow 1416, to a particular game near the middle of the games stack 1406. Should the user then navigate laterally to the left to an adjacent stack, such as to the communication applications stack 1404, the user may be presented with a first item at the beginning of the communications applications stack 1404, rather than an item at the same level of depth. Other navigation variations will also be apparent to those of skill in the art in light of the disclosure herein.

### Device-Management-Centric Interface

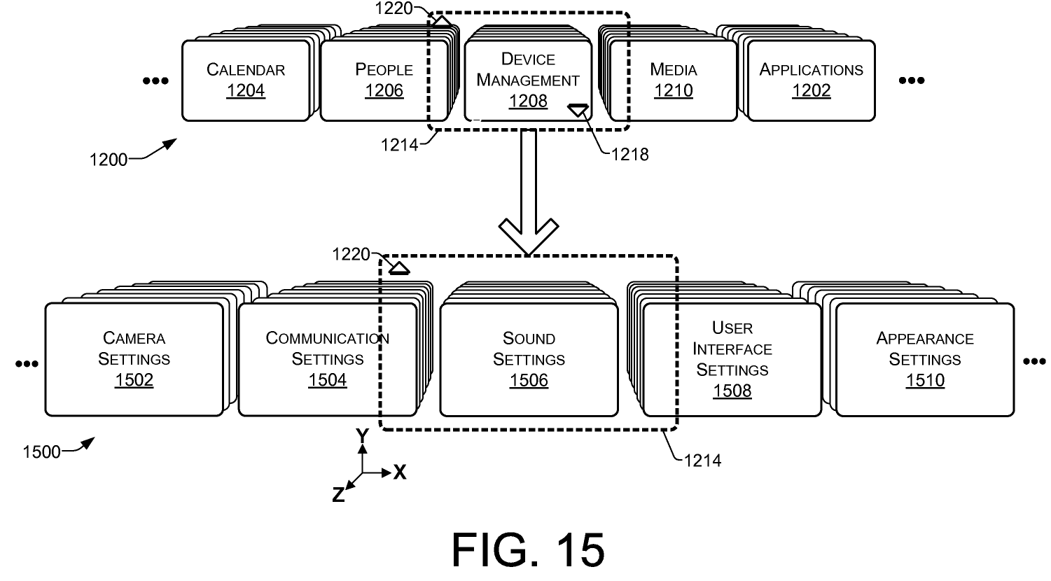

FIG. 15 illustrates an example of a device-management-centric interface 1500 according to some implementations. Device-management-centric interface 1500 may present a plurality of navigable stacks for management of the device 100, such as a camera settings stack 1502, a communication settings stack 1504, a sound settings stack 1506, a user interface settings stack 1508, and an appearance settings stack 1510. The camera settings stack 1502 may include a plurality of items for controlling camera settings such as light settings, flash settings, video settings, or the like. The communication settings stack 1504 may include a plurality of items for controlling communication settings such as WiFi settings, Bluetooth® settings, airplane mode, and so forth. Sound settings stack 1506 may include a plurality of items for managing sound settings such as ring tones and alerts for various functions. The user interface settings stack 1508 may include a plurality of items for controlling the settings of the user interface such as default navigation settings, control settings, such as the finger position control, tilt control, slider control, etc., as described above, and other user interface settings. The appearance settings stack 1510 may include a plurality of items such as for setting the display brightness, wallpaper, and the like.

Navigation among the stacks 1502-1510 in the device-management-centric interface 1500 may be similar to that described above with respect to the application-centric interface 1400. For example, as there is typically little correspondence or relationship between items in one stack 1502-1510 and items in another stack 1502-1510, navigation along the x-axis direction from a current stack to an adjacent stack may typically result in navigation to the first or beginning item in the adjacent stack, regardless of the depth level of navigation in the current stack.

### Media-Centric Interface

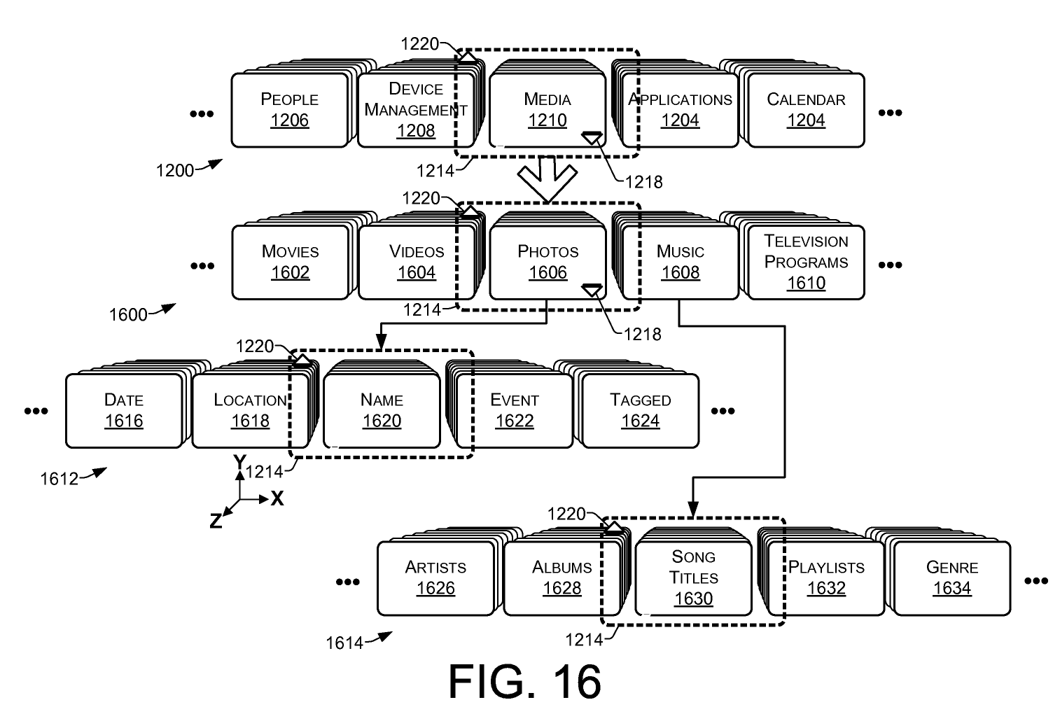

FIG. 16 illustrates an example of a media-centric interface 1500 available by expansion of the media stack 1210 according to some implementations. Media-centric interface 1500 may include a plurality of media-centric stacks such as a movies stack 1602, a videos stack 1604, a photographs stack 1606, a music stack 1608, and a television program's stack 1610, each of which may contain one or more items of the corresponding media type accessible by navigation along the z-axis direction. For example, media content items may be arranged in their corresponding stacks in alphabetical order, order of most frequent access, date created or modified, or other suitable order. Navigation among the stacks 1602-1610 in the media-centric interface 1600 may be similar to that described above with respect to the application-centric interface 1400. For example, as there is typically little correspondence between items in adjacent stacks 1602-1610, navigation along the x-axis direction from a current stack to an adjacent stack may typically result in presentation of the first or beginning item in the adjacent stack, regardless of the level of depth of navigation in the current stack at the time of the movement to the adjacent stack.

Additionally, the media item stacks 1602-1610 may be further expanded by selection of expansion control 1218, such as to create a photo-centric interface 1612 or a music centric interface 1614. For example, the photo centric interface 1612 may include a plurality of stacks related to different photograph storage categories based on how the photographs are stored or classified, such as a date stack 1616, a location stack 1618, a name stack 1620, an event stack 1622, and a tagged stack 1624. The date stack 1616 may include a plurality of items representing photographs arranged according to the date on which the photographs were taken. The location stack 1618 may contain a plurality of items representing photographs arranged according to the location at which the photographs were taken. For example, the location may be automatically recorded by a camera using a GPS, or the like, when the photo is taken. Alternatively, the user may tag the photos or otherwise identify the location of photos. The name stack 1620 may include a plurality of items representing photographs arranged according to the names of the people in the photographs. The event stack 1622 may contain photographs arranged according to particular events, such as holidays, birthdays, etc. The tagged stack 1624 may include a plurality of items representing photographs that have been tagged by the user or by others, and arranged according to the tags. Because there is typically little correspondence between adjacent items in the stacks 1616-1624, navigation on the x-axis direction from a current stack to an adjacent stack of the photo-centric interface 1612 may be configured to present the first or beginning item in the adjacent stack, rather than an item at an analogous level of depth.

The music-centric interface 1614 may have a plurality of stacks based on different music storage categories, such as an artists stack 1626, an albums stack 1628, a song titles stack 1630, a playlists stack 1632, and a genre stack 1634. The artists stack 1626 may contain a plurality of items representing songs listed according to artist, such as in alphabetical order or other suitable order. The albums stack 1628 may include a plurality of items representing albums, such as in alphabetical order or other suitable order. The song titles stack 1630 may include a plurality of items representing songs according to title, such as in alphabetical order or other suitable order. The playlists stack may include a plurality of items representing playlists, with each playlist containing a number of songs. The playlists may be created by the user or created automatically by an application on the device 100. The genre stack 1634 may include a plurality of items representing songs categorized according to various genres such as hip-hop, rock, classical, blues, country, etc.

Navigation laterally among the multiple stacks in the music centric interface 1614 may be a combination of navigation through an analogous level of depth and navigation to the front of a stack. Thus, the user interface may determine an appropriate navigation property based on the type of the adjacent stack being navigated to. For example, suppose that the user navigates along the z-axis direction in the song titles stack 1630, and arrives at a song entitled “Poker Face” by an artist named “Lady Gaga.” If the user then navigates along the x-axis direction to the albums stack 1628, the user may then be immediately presented with an analogous item representing an album entitled “The Frame” having the song “Poker Face” as one of the tracks. If the user continues to navigate to the next adjacent stack, the artists stack 1626, the user may be immediately presented with an item representing a list of songs by Lady Gaga, including “Poker Face.” If the user navigates to the genre stack 1634, the user may be immediately presented with an item representing pop genre that includes the song “Poker Face.” Further, if the user navigates to the playlist stack 1632, the user may be presented with an item representing a playlist that includes the song “Poker Face.” However, if there is no playlist that includes the song “Poker Face,” the user may instead be presented with the first item in the playlist stack 1632. The user may then scroll through the playlists along the z-axis direction to locate a playlist to which to add “Poker Face,” etc. Consequently, depending on the point at which navigation in the x-axis direction begins, navigation may either move to an analogous depth level in an adjacent stack, or may move back to the beginning of a stack. For example, suppose that the user is navigating along the z-axis direction through the playlist stack 1632, and arrives at a particular playlist. Navigation to an adjacent stack such as the song titles stack may result in the user being presented with the first or beginning item in the song titles stack 1630, as there typically would not be a single analogous item that is analogous to a particular playlist. On the other hand, if the user navigates to a particular playlist and selects a particular song in the particular playlist, and then navigates in the x-axis direction to an adjacent stack, such as the song titles stack 1630, the navigation may result in the immediate presentation of the particular song according to title. Other variations will also be apparent in view of the disclosure herein.

Additionally some of the stacks in the photo centric interface 1612 and the music centric interface 1614 may be further expanded to create additional multiple stack interfaces of even lower hierarchies. For example, in the photo-centric interface 1612, the event stack 1622 may be expanded to generate an interface of multiple stacks representing particular events such as holidays, birthdays, etc. Similarly, the genre stack 1634 in the music centric interface 1614 may be expanded to create an interface of a plurality of stacks, with each stack representing a different genre. Furthermore, the movies stack 1602, videos stack 1604, and television programs stack 1610 of the media-centric interface 1600 may each be similarly expanded to create additional multiple stack interfaces of lower level hierarchies similar to the photo-centric interface 1612 and the music centric interface 1614. Additional variations will also be apparent to those of skill in the art in light of the disclosure herein, with the foregoing being mere non-limiting examples presented for discussion purposes.

### Calendar-Centric Interface

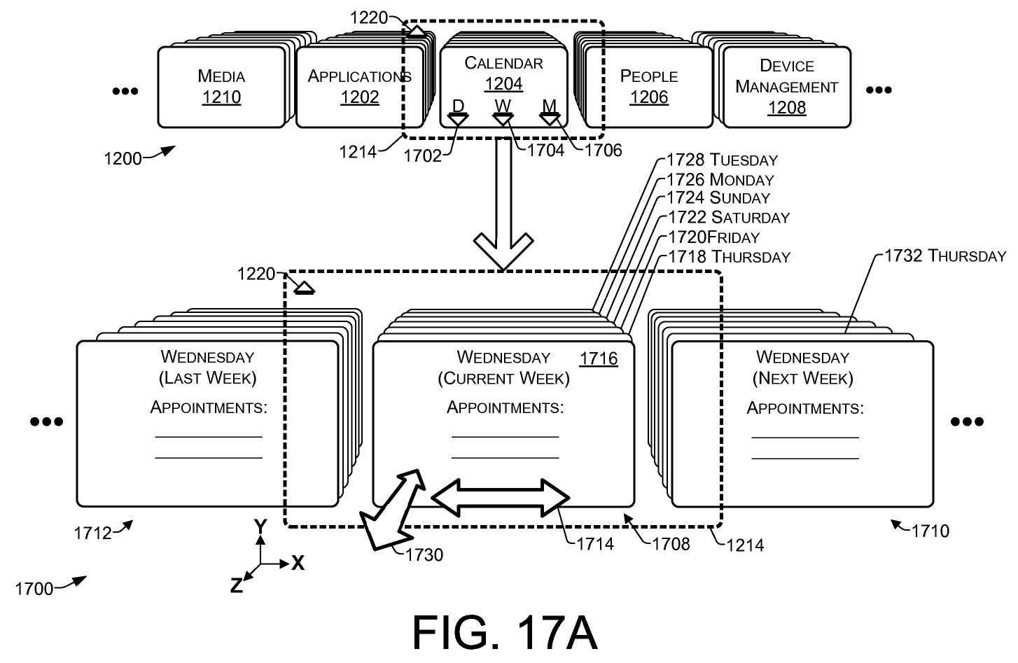

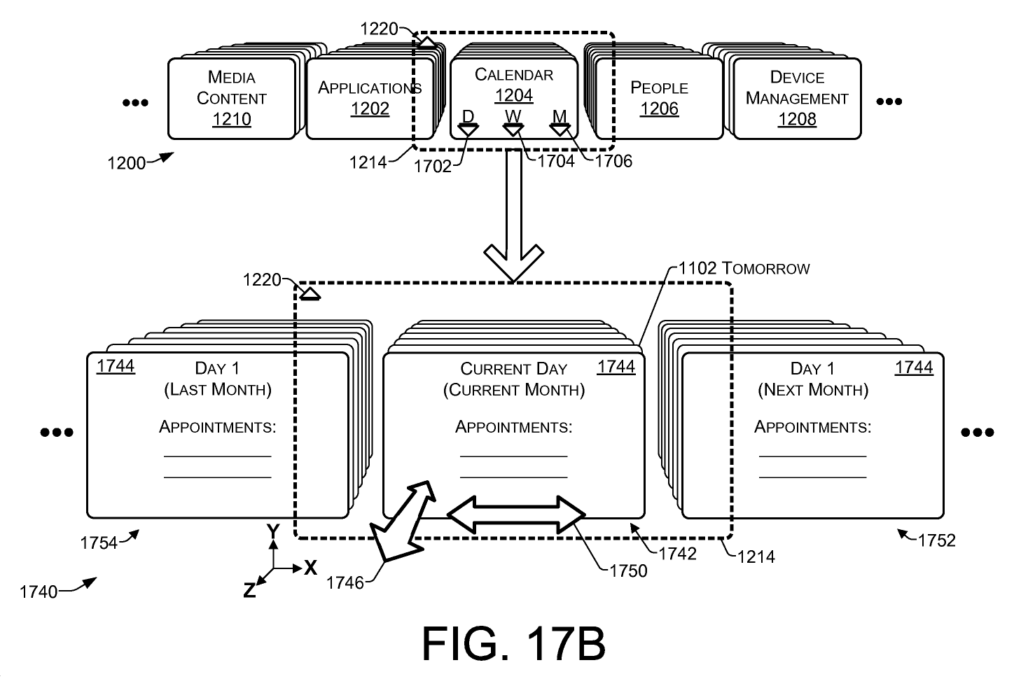

FIG. 17A illustrates an example of a calendar-centric interface 1700 according to some implementations. The calendar stack of the upper-level interface 1200 may be expanded to present a calendar-centric interface 1700. In order to generate an appropriate calendar-centric interface 1704 to meet a desired purpose, the user may be provided with a plurality of expansion control options, such as a day expansion control 1702, a week expansion control 1704, and a month expansion control 1706. For example, the day expansion control 1702 may be activated by the user to generate a calendar-centric day-view interface having a plurality of stacks in which each stack represents a different day, as was discussed above with reference to FIG. 11 (i.e., stacks 1110-1118). Furthermore, the week expansion control 1704 may be activated to generate a calendar-centric week-view interface having a plurality of stacks in which each stack represents a different week, as illustrated in FIG. 17A. Additionally, the month expansion control 1706 may be activated to generate a calendar-centric month-view interface having a plurality of stacks in which each stack represents a different month, as will be discussed below with reference to FIG. 17B.

In the example of FIG. 17A, as a result of activation of the week expansion control 1704, the user is presented with a calendar-centric week-view interface including a plurality of stacks, with each stack representing a week and being made up of a plurality of items, each representing a day of the week. Thus the user may be presented with a current week stack 1708, a next week stack 1710, a previous week stack 1712, and so forth. For example, should the user navigate in the x-axis direction, as indicated by arrow 1714, past the next week stack 1710, the user will be presented with a next stack representing the following week. Similarly, should the user navigate back in the direction of the x-axis in the other direction past the last week stack 1712, the user will be presented with a stack representing the immediately preceding week, etc. Thus, in some implementations, the stacks may be generated dynamically by the user interface as they are needed.

Further, the user may navigate through the days of the week by navigating along the z-axis direction. For example, suppose that the current day is Wednesday. The user activates the week expansion control 1704, and is presented with the stack for the current week 1708, with a first item 1716 representing Wednesday being displayed at the front of the current week stack 1708, such as for displaying any appointments scheduled for that day. The other days of the current week are available for navigation behind the first item 1716, namely a second item 1718 representing Thursday, a third item 1720 representing Friday, a fourth item 1722 representing Saturday, a fifth item 1724 representing Sunday, a sixth item 1726 representing Monday, and a seventh item 1728, representing Tuesday. Thus, the user may navigate forward or backward in the z-axis direction, as indicated by the arrow 1730 to view appointments scheduled for any day of the week. Further, should the user navigate to the left or right in the x-axis direction, the user may be presented with an item at the analogous level of depth. For example, suppose the user would like to schedule an appointment on a Thursday afternoon, and has navigated in the z-axis direction to second item 1718 representing Thursday. If there are no appointments available for this Thursday, the user may swipe the current week stack 1708 sideways to navigate in the x-axis direction and be immediately presented with item 1732 representing Thursday of next week in the next week stack 1710. Thus, in some implementations, navigation from one stack 1708-1712 to another stack 1708-1712 takes place at the same level of depth of navigation in the x-axis direction, i.e. to the same day of the week. Alternatively, in other implementations, the default navigation may be configured to start at the beginning of the adjacent week stack, such as by displaying Monday as the first item in an adjacent stack. Further, in some implementations, rather than displaying a seven-day week, the interface 1700 may be configured to display only a five-day week, such as Monday-Friday.

FIG. 17B illustrates an example of a calendar-centric month-view interface 1740 according to some implementations that is presented when the user activates the month expansion control 1706. The calendar-centric month-view interface 1740 may include a current month stack 1742 that presents the current day 1744 as a first item in the focus when the month expansion control 1706 is activated. The current day 1744 may show, for example, any appointments scheduled for the current day. The user may navigate along the z-axis direction, as indicated by arrow 1746, to be presented with items representing subsequent days of the current month, or in the opposite direction to be presented with items representing previous days of the current month. Thus, user may navigate to a second item 1748 representing tomorrow in the current month stack 1742 to view tomorrow's appointments.

Further, navigation in the x-axis direction to an adjacent stack, as indicated by arrow 1750, locates a next month stack 1752 or a last month stack 1754 within the focus 1214, depending on the direction of navigation. When navigating from a currently presented item in a current stack to an adjacent stack, in some implementations, the user is presented with the first day in the month represented by the adjacent stack, such as day one 1756 of the next month stack, or day one 1758 of the last month stack 1754. Alternatively, the interface may be configured to immediately present the same day of the adjacent month as the day of the current month that the viewer was viewing. For example, the user may be provided with options for setting the default navigation scheme. Further, while examples of a calendar-centric interface have been provided herein, other variations will be apparent to those of skill in the art in light of the disclosure herein.

### Category List Navigation

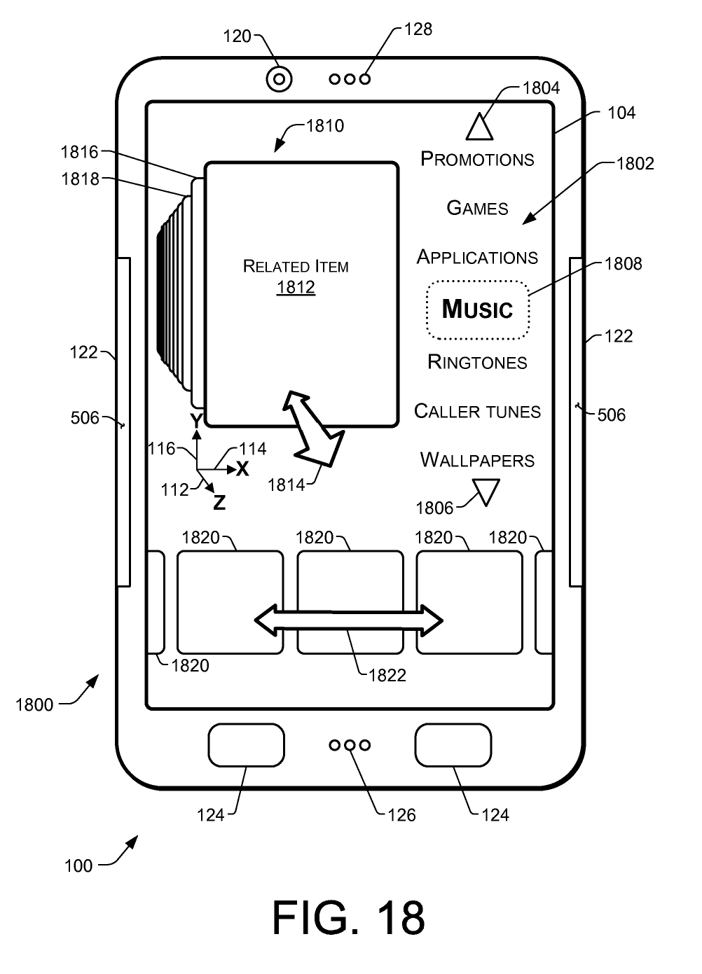

FIG. 18 illustrates an example of an interface 1800 that includes scrollable categories in conjunction with z-axis interaction, which may be implemented on a device, such as device 100. Interface 1800 may include a list 1802 of a plurality of words representing a plurality of navigation categories, such as “promotions,” “games,” “applications,” “music,” “ringtones,” “caller tunes,” “wallpapers,” “device management,” “calendar,” “videos,” and so forth. Further, not all of the categories may be visible in the interface 1800 at any one time, so a user may be able to scroll through the categories, such as in a continuous loop fashion, to view additional categories in the list. For example, in the illustrated configuration, the scrolling of the categories may take place along the y-axis direction, such as in either the up or down direction as indicated by arrows 1804, 1806, respectively. In the case in which display 104 is a touch screen, the scrolling may be performed by swiping or dragging of the list 1802, although other scrolling navigation controls may also be provided. The user may select one of the listed categories, which may result in the selected category being highlighted, enlarged, or the like. For example, a focus area 1808 may be provided, and a category may be selected by dragging the category into focus area 1808. Alternatively, by selecting a visible category from the list, such as with a tap, or the like, the focus area 1808 may move to a selected category anywhere on the visible portion of list 1802. Further, in such a case, in some implementations, the selected category and focus 1802 may then automatically move back to a central location in the list 1802, such as is illustrated in FIG. 18. In yet other implementations, the focus 1808 may be in a fixed location, such as the central location shown, and selection of a visible category outside of the focus may result in the selected category acting as a link that results in the immediate presentation of a related page or interface. For instance, in the illustrated example, if the user selected the “Applications” category outside of the focus 1808, such as by tapping, the interface 1800 may present the user with an applications-related page or the application centric interface 1400 discussed above.

Interface 1800 may also include a stack 1810 of items adjacent to the list 1802 of categories. For example, stack 1810 may include related items related to the categories in the list 1802. The related items may be displayed concurrently with the selection of a category, or with the passage of a corresponding category through the focus 1808 during scrolling of the list 1802. In some implementations, when a particular category is selected or located in the focus 1808, a related item 1812 is displayed at the front of the stack 1810. In the illustrated example, “music” is the currently selected category, and related item 1812 may be related to music. For example, related item 1812 may be a representation of a particular song or album, may be a graphic representing music in general, may be a music-related advertisement, or the like. Additionally, as a user scrolls other categories in list 1802 through the focus 1808 and/or selects other categories in list 1802, the stack 1810 can automatically scroll in the z-axis direction, as indicated by arrow 1814, in a contemporaneous manner. For example, a related item 1816 located immediately behind related item 1812 may be related to applications, i.e., the next category in list 1802, while a related item 1818 located behind related item 1816 may be related to games, and so forth. Additionally, as a next category in list 1802 enters the focus 1808 during scrolling of the list 1802, in some implementations, the currently-displayed related item may appear to fly out toward the user so that the next related item in the stack 1810 is displayed as the top or front item in stack 1810. Similarly, when the list 1802 is scrolled in the opposite direction, relate items of stack 1810 may appear to fly inward in the z-axis direction, onto the front of stack 1810.

Further, a plurality related representations 1820 may be displayed in another area of the interface 1800, such as below stack 1810 and list 1802. For example, related representations 1820 may be movable or scrollable in the x-axis direction, as indicated by arrow 1822. In some implementations, representations 1820 may be individual items, while in other implementations, representations 1820 may be stacks of items. For example, when music 1808 is selected, in some implementations, representations 1820 may be individual songs or albums, while in other implementations, representations 1820 may be a flow or group of stacks, such as stacks 1626-1634 in the music centric interface 1614 described above with reference to FIG. 16. The user may be able to adjust interface 1800 to center on and enlarge the music centric interface 1614, such as by double tapping a particular area of display 104, rotating device 100 sideways by 90 degrees, or the like. In other implementations, in which related representations 1820 represent individual songs or albums, a user may simply swipe related representations 1820 left or right in the x-axis direction to locate a desired item, such as a song, album, etc. Additionally, in some implementations, a user my select the related item 1812 displayed on top of the stack 1808, such as by tapping or the like, to open a related interface, such as the music centric interface 1614 discussed above. Other variations will also be apparent in light of the disclosure herein.

### Example Device

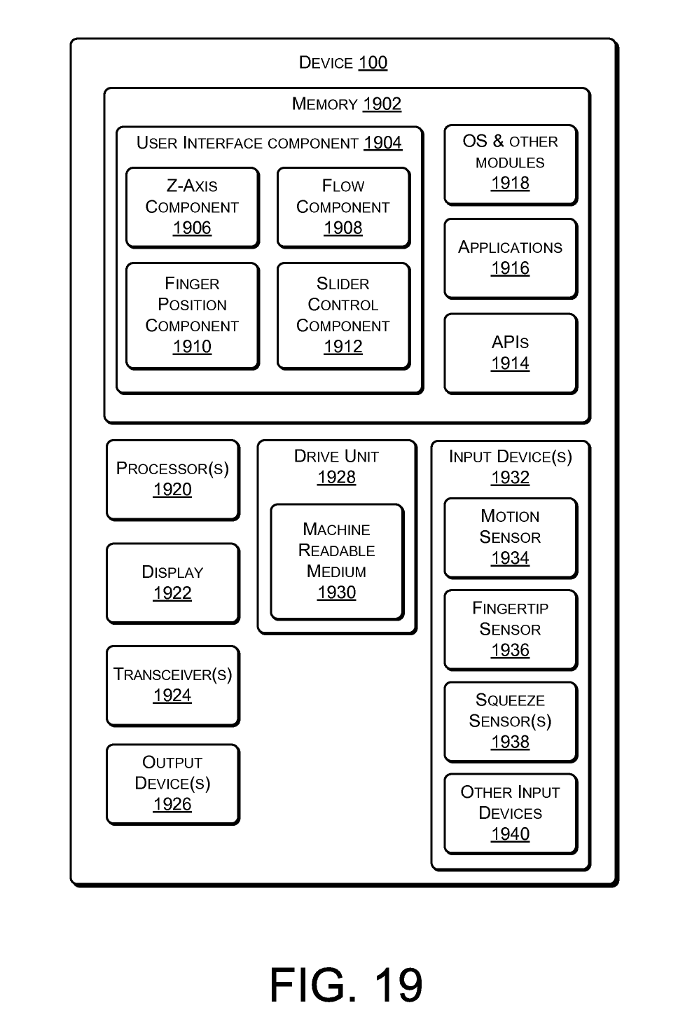

FIG. 19 illustrates an example of a component level view of the device 100 in accordance with some implementations, and which may correspond, for example, to a telecommunication device, touch screen device, tablet computing device, or the like. As shown, the device 100 may include a memory 1902 having a user interface component 1904 maintained thereon. The user interface component 1904 may include a z-axis component 1906 for implementing the z-axis scrolling functions described herein, a flow component 1908 for implementing the multiple movable stack interface described herein, a finger position component 1910 for implementing the finger position control described herein, and a slider control component 1912 for implementing the slider control described herein. Memory 1902 may also include APIs 1914, applications 1916, such as user applications, and an operating system (OS) and other modules 1918. The device 100 may further include one or more processors 1920, a display 1922, one or more transceiver(s) 1924, one or more output device(s) 1926, and a drive unit 1928 including a machine readable medium 1930, and input devices 1932. Input devices 1932 may include a motion sensor 1934, such as one or more accelerometers, a fingertip sensor 1936, such as finger position sensor 190 described above, one or more squeeze or grip sensor(s) 1938, such as squeeze or grip sensors 122 described above, and other input devices 1940.

In various implementations, memory 1902 generally includes both volatile memory and non-volatile memory (e.g., RAM, ROM, Flash Memory, miniature hard drive, memory card, or the like). Additionally, in some implementations, memory 1902 includes a SIM (subscriber identity module) card, which is a removable memory card used to identify a user of the device 100 to a telecommunication service provider.

In some implementations, the user interface component 1904 implements the user interfaces described above, including the user interface 102 and the user interface 800. The user interface component 1904, including the z-axis component 1906, the flow component 1908, the finger position component 1910 and the slider control component 1912 may comprise a plurality of executable instructions which may comprise a single module of instructions or which may be divided into any number of modules of instructions.

In various implementations, the APIs 1914 provides a set of interfaces allowing application providers to create user interfaces that provide for the z-axis scrolling and x-axis translation of sets of z-axis-scrollable items, as described herein. The interfaces of the APIs 1914 may in turn correspond to a set of functions, such as a function for generating a user interface or a function for enabling control of a user interface with a finger position control system or a slider. Such functions may take as parameters a set of parameters and user interface element pairs, as well as an identifier of the application, OS, platform, or device to which the user interface elements belong.

In various implementations, the applications 1916 and the OS and other modules 1918 comprise any executing instructions on the device 100. Such instructions include, for example, an OS of the device 100, drivers for hardware components of the device 100, applications providing interfaces to settings or personalization of the device 100, applications made specifically for the device 100, and third party applications of application providers. Collectively these applications/processes are hereinafter referred to as applications 1916 and OS and other modules 1918, which may be entirely or partially implemented on the device 100. In some implementations, the applications 1916 and OS and other modules 1918 are implemented partially on another device or server.

In some implementations, the processor 1920 is a central processing unit (CPU), a graphics processing unit (GPU), or both CPU and GPU, or other processing unit or component known in the art. Among other capabilities, the processor 1920 can be configured to fetch and execute computer-readable instructions or processor-accessible instructions stored in the memory 1902, machine readable medium 1930, or other computer-readable storage media.

In various implementations, the display 1922 is a liquid crystal display or any other type of display commonly used in devices, such as telecommunication devices. For example, display 1922 may be a touch-sensitive touch screen, and can then also act as an input device or keypad, such as for providing a soft-key keyboard, navigation buttons, or the like.

In some implementations, the transceiver(s) 1924 includes any sort of transceivers known in the art. For example, transceiver(s) 1924 may include a radio transceiver and interface that performs the function of transmitting and receiving radio frequency communications via an antenna. The transceiver(s) 1924 may facilitate wireless connectivity between the device 100 and various cell towers, base stations and/or access points.

Transceiver(s) 1924 may also include a near field interface that performs a function of transmitting and receiving near field radio communications via a near field antenna. For example, the near field interface may be used for functions, as is known in the art, such as communicating directly with nearby devices that are also, for instance, Bluetooth® or RFID enabled. A reader/interrogator may also be incorporated into device 100.

Additionally, transceiver(s) 1924 may include a wireless LAN interface that performs the function of transmitting and receiving wireless communications using, for example, the IEEE 802.11, 802.16 and/or 802.20 standards. For example, the device 100 can use a Wi-Fi interface to communicate directly with a nearby wireless access point such as for accessing the Internet directly without having to perform the access through a telecommunication service provider's network.

In some implementations, the output device(s) 1926 include any sort of output devices known in the art, such as a display (already described as display 1922), speakers, a vibrating mechanism, tactile feedback mechanisms, and the like. Output device(s) 1926 may also include ports for one or more peripheral devices, such as headphones, peripheral speakers, or a peripheral display.

The machine readable storage medium 1930 stores one or more sets of instructions (e.g., software) embodying any one or more of the methodologies or functions described herein. The instructions may also reside, completely or at least partially, within the memory 1902 and within the processor 1920 during execution thereof by the device 100. The memory 1902 and the processor 1920 also may constitute machine readable medium 1930. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices, such as memory 1902. Thus, the processes, components and modules described herein may be implemented by a computer program product.

In some implementations, fingertip sensor 1936 includes an imaging device or other component to recognize and track a position of a finger. Further, other input devices 1938 include any sort of input devices known in the art. For example, input device(s) 1938 may include a microphone, a keyboard/keypad, or a touch-sensitive display (such as the touch-sensitive touch screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Additionally, while an example device configuration and architecture has been described, other implementations are not limited to the particular configuration and architecture described herein. Thus, this disclosure can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### Multiple Stack Navigation

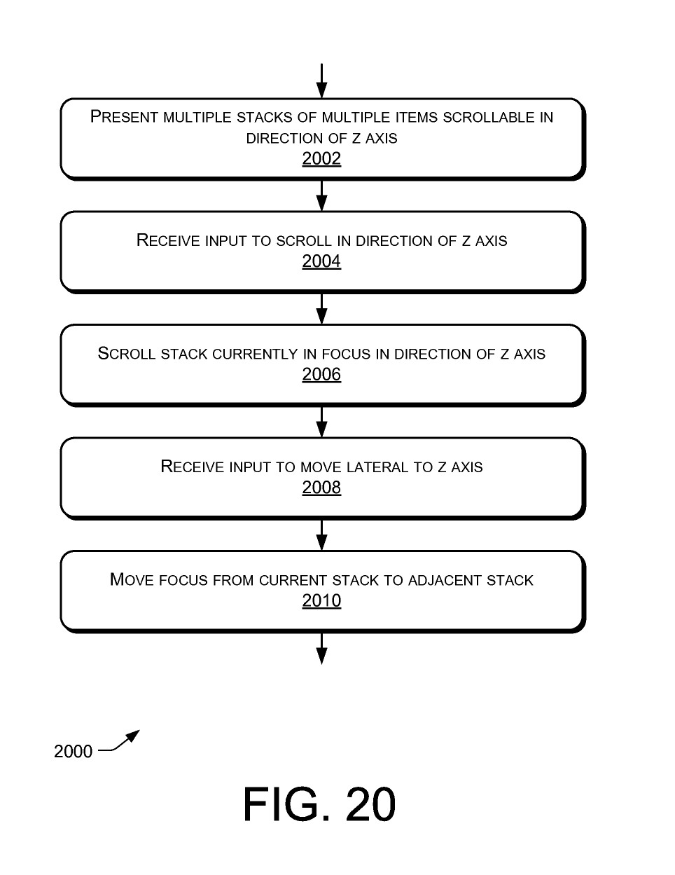

FIG. 20 illustrates an example of a process 2000 for multiple stack navigation according to some implementations herein. In the flow diagram, the operations are summarized in individual blocks. The operations may be performed in hardware, or as processor-executable instructions (software or firmware) that may be executed by one or more processors. Further, the process 2000 may, but need not necessarily, be implemented using the systems, environments and interfaces of FIGS. 8-18.

At block 2002, multiple stacks of multiple items scrollable in the z-axis direction are presented in a user interface 800. For example, each of the stacks is of a different data type, different application, or the like. The items in each stack may be presented and viewed by scrolling along the z-axis.

At block 2004, input is received to scroll in the direction of the z-axis. For example, input may be received from a finger position control system, from a slider, or from another input mechanism.

At block 2006, the user interface scrolls through one or more of the items in the stack that is currently in the focus of the user interface.

At block 2008, input is received to move the focus of the user interface laterally. For example, a user may swipe the representation of the currently presented item to the left or right to move in the direction of the x-axis. Other controls may also be used.

At block 2010, the user interface moves the focus to an item in the adjacent stack. For example, in some implementations, the focus may move to an analogous item or an item at the same depth as the item in the previous stack. In other implementations, the user interface may move the focus to the first or beginning item in the adjacent stack. For example, when the user interface receives an input to move an adjacent stack into the viewable area of the display, the user interface may determine a type or centricity of the adjacent stack for determining whether to present an analogous item of the adjacent stack or the beginning item of the adjacent stack in the user interface.

### CONCLUSION

Although the subject matter has been described in language specific to structural features and/or methodological acts, the subject matter defined in the appended claims is not limited to the specific features or acts described. Rather, the specific features and acts are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
providing a user interface on a display of a device, the user interface presenting a plurality of items arranged in a plurality of stacks, wherein
each stack comprises a plurality of items navigable in a direction oblique to a plane of the display, and
navigation from a particular stack presented in a focus of the user interface to an adjacent stack is by navigation in a direction within the plane of the display;
presenting a plurality of first stacks representing a first level of a navigation hierarchy; and
expanding a selected first stack to provide a plurality of second stacks, the plurality of second stacks representing a second level of the navigation hierarchy corresponding to the selected first stack.

2. The method according to claim 1, wherein
each first stack has a centricity that is different from a centricity of the other first stacks; and
the plurality of second stacks have a centricity based on the centricity of the selected first stack.

3. The method according to claim 2, wherein one of the first stacks is a people-centric stack and expansion of the people-centric stack provides the plurality of second stacks, each second stack representing a different application relating to a plurality of people, the method further comprising:
navigating in a currently presented one of the second stacks in the focus to a first item associated with a particular person; and
navigating an adjacent second stack into the focus, wherein the adjacent second stack presents a second item associated with the particular person.

4. The method according to claim 3, wherein when a particular adjacent second stack does not include an item associated with the particular person, the interface presents an item inviting a user to add information associated with the particular person to the particular adjacent second stack.

5. The method according to claim 2, wherein one of the first stacks is a calendar-centric stack, the method further comprising:
providing one or more expansion controls selectable for expanding the calendar-centric stack into the plurality of second stacks as one of a day view, a week view or a month view, wherein
expansion into the day view provides the plurality of second stacks, wherein each second stack represents a day and items in the second stack represent time slots in the day;
expansion into the week view provides the plurality of second stacks, wherein each second stack represents a week and items in the second stack represent days of the week; and
expansion into the month view provides the plurality of second stacks, wherein each second stack represents a month and items in the second stack represent days of the month.

6. The method according to claim 2, wherein one of the first stacks is an application-centric stack and expansion of the application-centric stack provides the plurality of second stacks, the plurality of second stacks each representing different categories of applications, the method further comprising:
navigating in a currently presented one of the second stacks currently in the focus to an item associated with a particular application; and
navigating an adjacent second stack into the focus, wherein the adjacent second stack presents a beginning item of the adjacent second stack.

7. The method according to claim 2, wherein one of the first stacks is a device-management-centric stack, and expansion of the device-management-centric stack provides the plurality of second stacks, the plurality of second stacks each representing different categories of device management options, the method further comprising:
navigating in a currently presented one of the second stacks currently in the focus to an item associated with a particular device management option; and
navigating an adjacent second stack into the focus, wherein the adjacent second stack presents a beginning item of the adjacent second stack.

8. The method according to claim 2, wherein one of the first stacks is a media-centric stack, and expansion of the media-centric stack provides the plurality of second stacks, the plurality of second stacks each representing different types of media content items, the method further comprising:
expanding a particular one of the second stacks to provide a plurality of third stacks based on the type of media content item of the particular second stack.

9. The method according to claim 8, wherein the particular second stack is a photo-centric stack, and expansion of the photo-centric stack provides the plurality of third stacks, the plurality of third stacks each representing different photograph storage categories, each of the plurality of third stacks including a plurality of items for representing photographs.

10. The method according to claim 8, wherein one of the particular second stacks is a music-centric stack, and expansion of the music-centric stack provides the plurality of third stacks, the plurality of third stacks each representing different music storage categories, wherein navigation from a current stack to an adjacent stack results in navigation to an analogous item in the adjacent stack or navigation to a beginning item of the adjacent stack, depending on the category of the adjacent stack.

11. The method according to claim 1, further comprising providing at least one of:
a control that is selectable to expand the selected first stack into the plurality of second stacks; or
a control that is selectable to collapse the plurality of second stacks into the first stack.

12. The method according to claim 1, wherein the control is provided as a virtual control presented on a touch screen display.

13. Computer-readable media containing instructions to be executed by a processor for implementing a user interface, the user interface comprising:
a plurality of stacks generated for presentation on a display, each stack comprising a beginning item and a plurality of items behind the beginning item, the plurality of items of each stack being navigable in a direction oblique to a plane of the display to sequentially display items in the stack, wherein
following navigation in the direction oblique to the plane of the display to a particular item in a first stack, when the user interface receives an input to move an adjacent second stack into a viewable area of the display, the user interface determines a type of the second stack for determining whether to present an analogous item of the second stack or the beginning item of the second stack in the user interface.

14. The method according to claim 13, wherein the beginning item of the second stack is presented when the items in the second stack do not have a correspondence with the items in the first stack.

15. The computer readable media according to claim 13, wherein
the second stack and the first stack each have items identified according to people; and
navigation to the second stack from an item related to a particular person in the first stack results in presentation of a particular item of the second stack related to the particular person.

16. The computer readable media according to claim 13, wherein
the second stack and the first stack each have items identified according to an artist or a song; and
navigation to the second stack from an item related to a particular artist or song in the first stack results in presentation of a particular item of the second stack related to the particular artist or song, respectively.

17. A device comprising:
a display;
a processor in communication with computer-readable media;
a user interface component, maintained in the computer-readable media and executed on the processor, to present a user interface on the display, the user interface comprising:
a plurality of stacks, each stack comprising a plurality of items navigable in a direction oblique to a plane of the display for successively presenting the items in the stack, wherein a first stack is presented in a viewable area of the display and an adjacent second stack is moveable in a direction in a plane of the display to replace the first stack in the viewable area.

18. The device according to claim 17, further comprising at least one control that is selectable to perform at least one of:
expand a stack displayed in the viewable area of the display into a plurality of stacks of a lower hierarchical level; or
collapse a plurality of stacks into a single stack of a higher hierarchical level.

19. The device according to claim 18, wherein the display is a touch screen and the at least one control comprises multiple virtual controls displayed on the display, wherein a first virtual control expands a stack and a second virtual control collapses a plurality of stacks.

20. The device according to claim 17, wherein when a currently displayed stack is a calendar-centric stack, the interface provides at least one control to expand the stack into at least one of:
a day view that provides a plurality of day stacks, wherein each day stack represents a day and items in the day stack represent time periods in the day;
a week view that provides a plurality of week stacks, wherein each week stack represents a week and items in the week stack represent days of the week; and
a month view that provides a plurality of month stacks, wherein each month stack represents a month and items in the month stack represent days of the month.

21. A device comprising:
a display;
a processor in communication with computer-readable media; and
a user interface component, maintained in the computer-readable media and executed on the processor, to present a user interface on the display, the user interface comprising:
a scrollable list of categories; and
a stack of items related to the categories, wherein as the list of categories is scrolled, the stack of items scrolls in a direction oblique to a plane of the display.

22. The device according to claim 21, wherein when a particular category of the list of categories is selected, a related item related to the particular category is displayed at as a front item of the stack of items.

23. The device according to claim 22, the user interface further comprising a plurality of related representations displayed in the user interface, wherein the plurality of related representations are related to the particular item and the particular category.

24. The device according to claim 23, wherein:
the plurality of related representations are scrollable in a direction corresponding to the plane of the display; and
the plurality of related representations comprise at least one of;
stacks of items related to the particular category, or
individual items related to the particular category.
